(19) United States
(12) Patent Application Publication
(10) Pub. No.: US 2024/0393278 A1
(43) Pub. Date: Nov. 28, 2024

(54) LASER DRIVEN ULTRAFAST IMPEDANCE SPECTROSCOPY

(71) Applicant: California Institute of Technology, Pasadena, CA (US)

(72) Inventors: Scott K. Cushing, Glendale, CA (US); Kim Pham, Pasadena, CA (US)

(73) Assignee: California Institute of Technology, Pasadena, CA (US)

(21) Appl. No.: 18/405,313

(22) Filed: Jan. 5, 2024

Related U.S. Application Data
(60) Provisional application No. 63/543,666, filed on Oct. 11, 2023.
(60) Provisional application No. 63/437,200, filed on Jan. 5, 2023.

(51) Int. Cl. G01N 27/04

(52) U.S. Cl. CPC G01N 27/041

(57) ABSTRACT

An apparatus including a source of electromagnetic radiation comprising one or more first frequencies; a source of an input signal comprising an alternating (AC) electric field comprising one or more second frequencies; a control circuit synchronizing application of the electromagnetic radiation and the AC electric field applied to a sample, so that an output signal comprising a modulation of the AC electric field is outputted from the sample in response to (1) the one or more second frequencies tuned to drive hopping of ions between ion sites in the sample, and the one or more first frequencies tuned to drive excitations in the sample that interact with the ions. The apparatus further includes a detection system measuring and/or detecting a change in the output signal in response to the electromagnetic radiation; and a computer determining at least one of a conductivity or impedance of the sample from the output signal and as a function of the first frequencies and the second frequencies.

### CROSS REFERENCE TO RELATED APPLICATIONS

This application claims the benefit under 35 U.S.C. Section 119 (e) of commonly assigned and co-pending:
U.S. Provisional Application No. 63/437,200, filed Jan. 5, 2023, by Scott K. Cushing and Kim Pham, entitled “LASER DRIVEN ULTRAFAST IMPEDANCE SPECTROSCOPY,” CIT 8941-P; and
U.S. Provisional Application No. 63/543,666, filed Oct. 11, 2023, by Scott K. Cushing and Kim Pham, entitled “LASER DRIVEN ULTRAFAST IMPEDANCE SPECTROSCOPY,” CIT 8941-P2;
both of which applications are incorporated by reference herein.

### STATEMENT REGARDING FEDERALLY SPONSORED RESEARCH AND DEVELOPMENT

This invention was made with government support under Grant No. FA9550-21-1-0022 awarded by Air Force. The government has certain rights in the invention.

### BACKGROUND OF THE INVENTION

### 1. Field of the Invention

The present disclosure relates to a spectroscopy system and method of making and using the same.

### 2. Description of the Related Art

Modern batteries rely on solid state and polymer electrolytes with conductivities that can exceed water. For this to be possible, ions must hop between vacant sites on the order of picoseconds. The mobility is determined by how the lattice electronically screens and mechanically deforms to aid or resist these ion hops. Current battery characterization techniques concentrate on measuring overall bulk mobilities through impedance spectroscopy or identifying hopping sites with NMR or neutron scattering. However, to date, no technique exists that can 1) measure ultrafast ion hopping on its inherent timescale and 2) quantify how the interactions of the ion with the electron screening cloud, phonons, or higher order combinations of ion-ion, ion-electron-phonon, or ion-phonon-phonon interactions lead to ionic conduction. For example, a comparative study using modern techniques to extrapolate these processes led to a more than nine order of magnitude spread in hopping frequency estimate for the same material. What is needed then, are improved methods of studying ion transport in materials. The present invention satisfies this need.

### SUMMARY OF THE INVENTION

The present disclosure reports on a new type of impedance spectroscopy wherein CW source or a laser (or similar frequency tunable light source) is swept across a broad frequency range corresponding to excitations such as, but not limited to, electron, ion, phonon excitations, or any combination thereof. The change in an AC field at a frequency covering different ion hopping regions (e.g., ranging from contact to grain boundary to bulk effects in the case of a solid electrolyte) is then measured as a function of the driving frequency. The resulting time dependent response can measure individual ion hopping on picosecond or faster timescales. Comparing the response at multiple driving frequencies, or combinations of pulses with different time delays at different frequencies, gives the relative strength of the process on the ion hopping process. Overall, the quantum mechanical Hamiltonian is mapped out, providing in-depth information on how the ion hopping occurs but also the most important aspect for material's engineering. Several versions of the instrument are described with varying levels of complexity and cost depending on the depth or nature of the information to be measured. Although illustrated in the context of battery electrodes and electrolytes, the technique is applicable to any ion-conduction or mixed ion-conduction system.

A byproduct of the measurement technique is the realization of the laser-driven, increased ionic conduction that changes the overall impedance of the battery. The ionic conductor, or any application thereof, can be modulated by light depending on frequency. Some such effects last for minutes after a femtosecond excitation pulse, leading to potential technology applications.

Illustrative embodiments include, but are not limited to, the following embodiments.

1. A system, comprising:
a first source of electromagnetic radiation (EM) comprising one or more first frequencies;
a second source of an input signal comprising an alternating (AC) electric field comprising one or more second frequencies;
a control circuit connected to the first source and the second source for synchronizing application of the electromagnetic radiation and the AC electric field applied to a sample, so that an output signal comprising a modulation of the AC electric field is outputted from the sample in response to:
   the one or more second frequencies tuned to drive hopping of ions between ion sites in the sample, and
   the one or more first frequencies tuned to drive excitations in the sample that interact with the ions;
a detection system positioned for measuring and/or detecting a change in the output signal in response to the electromagnetic radiation; and
a computer connected to the detection system for determining at least one of a conductivity or impedance of the sample from the output signal and as a function of the first frequencies and the second frequencies.

2. The system of embodiment 1, wherein the control circuit controls or further comprising a control circuit for controlling:
a sweep of the first frequencies over a first range to drive the excitations of electrons, ions, and/or phonons in the sample comprising an electrolyte, and
a sweep of the second frequencies over a second range such that the input signal drives ion hopping in the electrolyte over a variety of ion migration time-scales.

3 The system of embodiment 2, wherein the computer determines, or is programmed to determine, a change in the conductivity at one or more of the second frequencies associated with the migration time-scales in different ion hopping regions in the electrolyte including at least one of a contact region, a grain boundary, or a bulk region.

4. The system of embodiment 3, wherein the electrolyte comprises a solid electrolyte for a battery.

5. The system of embodiment 4, wherein the sample comprises electrical contacts to the solid electrolyte comprising lithium ions for a lithium ion battery.

6. The system of embodiment 1, wherein computer determines or is programmed to determine, from the output signal, a Hamiltonian for the sample describing an interaction between the excitations excited by the electromagnetic radiation and the hopping driven by the input signal.

7. The system of embodiment 1, wherein the first source of electromagnetic radiation comprises a pulsed or continuous (CW) laser outputting the first frequencies in a range between an ultraviolet (UV) frequency and THz.

8 The system of embodiment 1, wherein the first source of electromagnetic radiation comprises a lamp outputting the electromagnetic radiation.

9. The system of embodiment 1, wherein the second source of the input signal comprises a signal generator outputting the second frequencies in a range from 1 Hz to 1 THz.

10. The system of embodiment 1, wherein the detection system measures or comprises a circuit for measuring or detecting the output signal on a timescale of the excitations driven by the electromagnetic radiation.

11. The system of embodiment 1, wherein the first source of electromagnetic radiation comprises a pulsed laser for outputting pulses of the electromagnetic radiation having a full width at half maximum (FWHM) of 1 nanosecond or less and the detection system comprises a circuit for measuring the change with a time resolution of the envelope of the FWHM.

12. The system of embodiment 1, wherein the first frequencies comprise terahertz frequencies.

13. The system of embodiment 1, further comprising a sample holder for holding the sample, wherein the sample holder comprises:
a vertical launch connector for physically connecting to a microstrip on the sample;
a metal plate comprising at least one opening for insertion of the sample and coupling of the electromagnetic radiation into the sample; and
fasteners for fastening the sample between the vertical launch connector and the metal plate so that the input signal is transmitted from the vertical launch connector to the microstrip and a reflection of the input signal (comprising the output signal) is outputted from the microstrip to the vertical launch connector.

14 The system of embodiment 13, further comprising a directional coupler coupling the vertical launch connector to:
the second source of the input signal via a first coaxial cable; and
the detection system via a second coaxial cable.

15. The system of embodiment 1, further comprising a time resolved vector network analyzer comprising the second source of the input signal comprising a signal generator and the detection system comprising an oscilloscope triggered by a photodiode detecting the electromagnetic radiation.

16. The system of embodiment 1, wherein the detection system measures or comprises a circuit for measuring the change without time-resolution on a time-scale of the application of the electromagnetic radiation, and the computer is programmed for determining the conductivity using normalization to exclude contributions of steady state heating by the input signal and for the sample comprising a thin film.

17. The system of embodiment 1, wherein the detection system comprises an IQ demodulator coupled to a photodetector detecting the electromagnetic radiation, so that an amplitude and phase of the output signal (current and voltage) can be measured using the IQ demodulator and associated with time resolution to changes in the time-envelope of the electromagnetic radiation.

18. The system of embodiment 1, wherein the detection system comprises a circuit for measuring or detecting the output signal to determine a change in a complex impedance of the sample and the computer determines or is programmed for determining the conductivity from the complex impedance.

19. The system of embodiment 1, wherein the detection system comprises an impedance analyzer.

20. A method of measuring conductivity, comprising:
irradiating a region of a sample with electromagnetic radiation comprising one or more first frequencies;
applying an input signal to the region, the input signal comprising an alternating (AC) electric field comprising one or more second frequencies, so that the electromagnetic radiation and the input signal are applied synchronously;
measuring and/or determining an output signal comprising a modulation of the AC electric field in response to:
   the one or more second frequencies tuned to drive hopping of ions between sites in the sample, and
   the one or more first frequencies tuned to drive excitations in the region that interact with the ions; and
determining, from the output signal, a conductivity of the sample as a function of the first frequencies and the second frequencies.

21. The method of embodiment 20, wherein the sample comprises any material system (biological or non biological) conducting ions.

### BRIEF DESCRIPTION OF THE DRAWINGS

Referring now to the drawings in which like reference numbers represent corresponding parts throughout:

FIG. 1 Schematic of the time-resolved ultrafast impedance set up, including the laser, a representative nonlinear frequency generation process (to cover the UV to THz excitation range), VNA, and the sample cell.

FIGS. 2a-2f Calculated phonon contributions to Li-ion hopping, THz absorbance, and representative modes between 0 6 THz of LLTO. FIG. 2a, the disaggregated accumulation of normalized contributions to ion hopping. The grey dashed line indicates the experimental limit in THz generation (6 THz). FIG. 2b shows the normalized contribution of 120 individual modes to Liion hopping. The red represents low energy (E) phonon modes while the blue represents higher energy modes. c, LLTO THz absorbance (orange) versus calculated phonon hop contribution (bar graph). d-g, phonon modes that highly contribute to Li-ion hopping through the front-facing 4-O window (g) or not involved (d-f).

FIG. 3a. Picture of the gap electrode design on an LLTO pellet. Also done as reference. The cell temperature was controlled using a TC-48-20 OEM temperature controller, 12 V power supply, and corresponding TC48-20 OEM software. The heating cell was placed inside a faraday cage for all experiments to reduce noise from electromagnetic interference. A copper mesh was custom-made with a 1.4 mm copper wire spacing.

FIG. 3b. Schematic of a sample comprising electrodes in contact with the electrolyte.

FIGS. 4a-4d. Characterization of LLTO including FIG. 4a, the XRD pattern, FIG. 4b, an SEM showing the 1-10 μm grain size in the pellet, and FIG. 4c. the bulk and FIG. 4d. grain boundary parts of the impedance spectrum. pellet with a 1 mm gap in the center for the light source to excite the LLTO to eliminate possible effects on the impedance from illuminating the Au (FIG. 2). FIG. 4a-4d shows the XRD pattern, the 1-10 μm grain size, and a representative impedance plot.

FIG. 5. Diagram of the THz field set up. OPA: Optical Parameter Amplifier. OAP: Off-Axis Parabolic. FL: focal lens, P: polarizer, PDs: Photodiodes

FIGS. 6a-6d. The change in conductivity of an LLTO sample from 1 Hz to 50 GHz. Excitation of a charge-transfer transition reduces the coulombic hopping barrier, increasing conductivity (black solid line). FIG. 6a shows the change, red area, is greater than optically heating the lattice (black dashed line). FIG. 6b. A unit cell for LLTO and a schematic for how the photoexcited charge transfer transition clears up electron density in the Li ion conduction pathway. In the unit cell, Li ions are purple, O is red, La is green, and Ti is grey in the center of the octahedral. FIG. 6c shows a representative time-resolved change in conductivity on the picosecond timescale. FIG. 6d shows linearity in the signal response against excitation power.

FIGS. 7a-7d. THz interaction with LLTO. The orange, blue, purple, and gray atoms correspond to oxygen, titanium, lanthanum, and lithium respectively. FIG. 7a, at t₁=0, an impedance analyzer records the EIS spectra before, during, and after THz excitation. FIG. 7b, during t₂>t₁, the THz light resonantly drives contributing modes, increasing the phonon occupation. FIG. 7c, with continuous THz irradiation, energy transfer between the phonons to the Li-ion and bottleneck opening occurs, causing facile Li-ion hopping, manifesting as a decreased impedance. FIG. 7d, upon removal of the THz source, the phonon occupation and impedance return to its original state (a).

FIG. 8. Electrochemical heating cell set-up to obtain the power-to temperature calibration curve and collect EIS data below 32 MHz with the 1260 A Solartron. The cell components are compressed and held together with screws that fit through the five holes indicated. Each screw is secured with wingnuts.

FIG. 9a|The absorption spectrum across the UV-Vis to THz frequency range showing enhancement in migration across near-IR (NIR), mid-IR (MIR), and THz light. The change in R_{bulk} per change in sample temperature (K) is represented by the horizontal orange bar and further defined by the black gradient. The NIR enhancement and DC heating corresponds to incoherent heating of the acoustic phonon bath. The MIR excitation corresponds to coherent driving of optical phonon modes. The THz light coherently drives highly contributing modes, showing the largest relative enhancement. The width of the horizontal orange bar represents the spectral width of the excitation pulse. In comparison, FIG. 9a plots the absorption spectrum across the UV-Vis to THz frequency range, and the width of the orange bars representing the bandwidth of the excitation source shows that the THz is more broadband compared to the other excitation sources.

FIG. 9b. THz absorption measured in LLTO compared to the theoretically predicted contribution of the excited THz rocking modes to ion conduction.

FIGS. 10a-10d. Nyquist plots of LLTO between 298 K-333 K and from targeted phonon excitation with THz. FIG. 10a, the grain boundary feature, and FIG. 10b, the bulk feature, of LLTO. The open symbols correspond to the data. The line represents the fit. FIG. 10c, The Nyquist plot of LLTO with 0-1.6 mW of THz excitation. The change in Z′ is compared at single frequencies 803 kHz and 32 Hz, corresponding to bulk and grain boundary resistance respectively. FIG. 10d, the percent change in impedance versus power. The linearity of this data rules out non-linear effects from the THz driving field.

FIGS. 11a-11c. FIG. 11a is a schematic of vertical launch with an exposed pin that makes electrical contact with the sample under study. FIG. 11b shows the sample sits inside a well that is 300 microns in depth and 2 mm in diameter with a 2 mm thick hole drilled on the side for simultaneous irradiation of the sample. FIG. 11c shows the vertical launch is connected to the S12 port of the directional coupler. The S11 port allows reflection measurements against the reflected, unperturbed wave supplied by port S13.

FIG. 12. The change in conductivity of an LLTO sample from 2 Hz to 110 GHz. Excitation of a charge-transfer transition reduces the coulombic hopping barrier, increasing conductivity (black solid line). The change, shown as the red area, is greater than optically heating the lattice (black dashed line). The dotted line shows the conductivity of LLTO with the blocked laser.

FIG. 13. The change in conductivity of an LLTO sample from 2 Hz to 110 GHz due to 350 nm light. Representative time-resolved change in conductivity on the picosecond timescale.

FIGS. 14a-14e. Change in impedance upon band-gap excitation with 349 nm light between 5-20 mW. FIG. 14a shows grain boundary semicircle fit to a R1+R_{GB}/Q2 circuit. FIG. 14b shows bulk impedance semi-circle fit to a R1+R_{Bulk}/Q2 circuit. FIG. 14c shows grain boundary and FIG. 14d bulk replicates across three samples showing the change in impedance upon 349 nm light excitation over 5-20 mW at a frequency corresponding to the respective intercept of the semi-circle feature. FIG. 14e shows percent change in impedance as a function of 349 nm laser power shows a linear response for both the grain boundary and bulk.

FIG. 15. Flowchart illustrating a method of making a device.

FIG. 16. Flowchart illustrating a method of performing spectroscopy.

FIG. 17. Example hardware environment for performing computer and/or control functions described herein.

FIG. 18. Example network system for performing computer and/or control functions described herein.

FIGS. 19a-19c. Example detection systems comprising a PLL detector (FIG. 19a), IQ modulator (FIG. 19b) and an amplitude detector (FIG. 19c) further illustrating optional connection to synchronizing or trigger circuit.

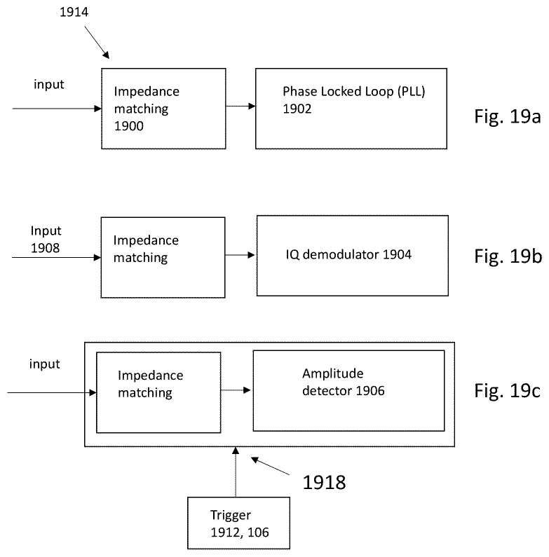

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### 1. System Components

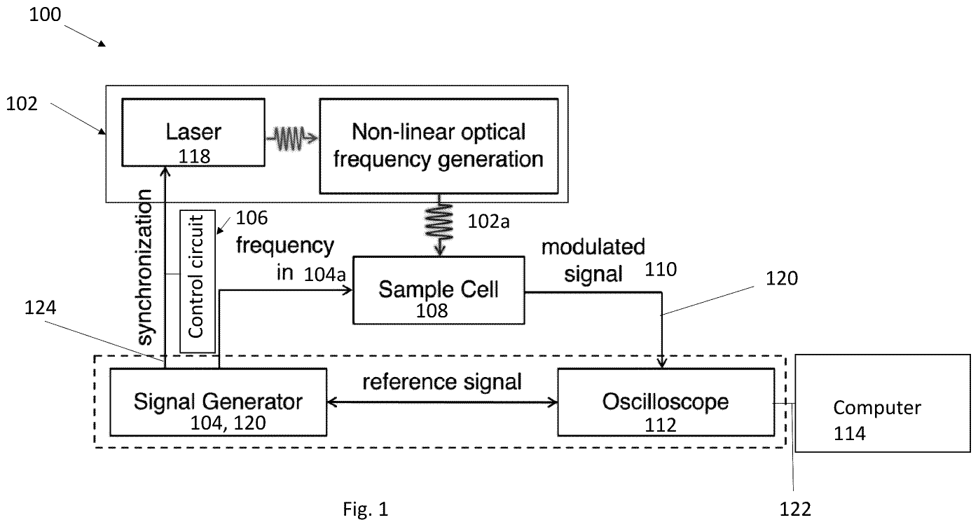

FIG. 1 illustrates a spectrometer, apparatus, device or system 100, comprising a source 102 of electromagnetic radiation comprising one or more first frequencies; a source 104 of an input signal comprising an alternating (AC) electric field comprising one or more second frequencies; and a control circuit 106 synchronizing application of the electromagnetic radiation and the AC electric field applied to a sample 108, so that
(1) an output signal 110 comprising a modulation of the AC electric field is outputted from the sample in response to the one or more second frequencies tuned to drive hopping of ions between ion sites in the sample, and
(2) the one or more first frequencies tuned to drive excitations in the sample that interact with the ions.

The spectrometer further comprises a detection system 112 measuring a change in the output signal in response to the electromagnetic radiation; and a computer determining at least one of a conductivity or impedance of the sample from the output signal and as a function of the first frequencies and the second frequencies.

FIG. 1 illustrates an embodiment comprising a laser-driven ultrafast impedance spectrometer using a nonlinear mixer (nonlinear optical frequency generation). In another configuration, a continuous wave light source (e.g., high power lamp or CW laser) can be coupled with a standard impedance analyzer (e.g., 1260 A Solartron) when a steady state condition is being measured. However, since it can be difficult to obtain sufficient average powers across the UV to THz range with current CW light sources, a pulsed laser can also be used, although in this case careful control data must be taken because of duty cycle averaging. In this CW version of the instrument only relative (instead of absolute values) for the second order (ion with electron or phonon) Hamiltonian components can be obtained with cross-correlation terms (ion-electron-phonon, etc) being inferred. However, this is still vital information for many applications including, but not limited to, solid state ion conductor design.

### 2. Example Ionic Conductivity Calculation

In electrochemical impedance spectroscopy (EIS), a sinusoidal potential perturbs the sample of interest (Eq. 1) where U(t) is the potential as a function of time t, U₀ is the amplitude of the potential, and f is the frequency 46:

$$U ( t ) = {U}_{0} sin ( 2 π f t ) \qquad ( 1 )$$

The interaction with the sample will cause a change in the phase and amplitude of the measured response (as current or potential) as shown in Eq.2, where I(t) is the current as a function of time, I₀ is the amplitude of the current, and Θ is the phase angle.

$$I ( t ) = {I}_{0} sin ( 2 π f t + Θ ) \qquad ( 2 )$$

The complex impedance can then be derived from the amplitude Z=U₀/I₀ and phase angle Θ, i.e., the phase shift between the measured U (t) and/(t) for a frequency f. While EIS cannot decouple conduction caused by multiple mobile charge carriers, EIS remains a useful tool to study ionic conduction in many solid-state conductors. In the literature, FFT EIS⁴⁷⁻⁴⁹, online EIS^{50,51}, and fast-time resolved techniques^{49,52,53} have been developed to access faster hopping regimes but do not use the pump to drive ion migration.

Moreover, the present disclosure describes, to our knowledge, the first method that can reach up to 40-110 GHz due to recent advances in electronics, with previous reports only reaching 1-3 GHz^{46,49,50,54,55}. Ultimately, the bandwidth of the signal generator and oscilloscope determines the temporal and frequency resolution, and using frequency extenders could reach into the THz range.

In one embodiment of a time-resolved impedance measurement technique, the signal generator generating kHz to 110 GHz frequencies is used as the perturbing signal to match the timescales of the ion hopping mechanism. The oscilloscope can be used to measure the potential change, current change, and phase shift for the same frequencies, all of which are used to derive impedance.

However, above tens of MHz, directly measuring the current versus potential change becomes impractical as values of capacitance and inductance become too small to measure (sub picofarad and sub nanohenry, respectively)⁵⁶. Instead, scattering parameters are measured to determine the amplitude and phase changes associated with impedance as shown by Eq.3.1^{43,56}, where VSWR is the voltage standing wave ratio, or the efficiency of transmission of a radio frequency power source to the load through a transmission line, S11 is the reflection scattering parameter, Γ is the reflection coefficient, Z₀ is the reference ohm (typically 50 ohm), and Z_{L} is the sample impedance or load.

$$VSWR = \frac{1 + \vert S 11 \vert}{1 - \vert S 11 \vert} \qquad ( 3 )$$

$$Γ = \frac{VSWR - 1}{VSWR + 1}$$

$${Z}_{L} = {Z}_{0} * \frac{1 + Γ}{1 - Γ}$$

Since the S11 is measured directly from the VNA, the Z_{L} can be calculated and subsequently the ionic conductivity.

### 3. First Example Measurements of Ultrafast Ion Hopping in LLTO

a. Theoretical Framework

The fundamental mechanism of ion conduction (σ) relies on the activation energy (E_{A}) of the ion hop and temperature (T) as shown in eq. 4.

$${σ}_{ion} = \frac{{σ}_{0}}{T} * exp ( - \frac{{E}_{a}}{{k}_{B} T} ) \qquad 4$$

However, σᵢₒₙ relies on many more factors that are revealed after expanding the Arrhenius pre-factor σ₀ as shown in eq. 5.⁷

$${σ}_{ion} = \frac{1}{T} [ \frac{{( Ze )}^{2}}{{k}_{B}} {zca}_{0}^{2} {v}_{0} * exp ( \frac{Δ {S}_{m}}{{k}_{B}} ) ] exp ( - \frac{Δ {H}_{m}}{{k}_{B} T} ) \qquad 5$$

The probability of an ion hop is determined by the attempt frequency (v₀), the jump distance (a₀), the activation energy barrier (ΔHₘ or experimentally E_{A}), and the temperature (T). From eq. 5, σ₀∝exp (ΔSₘ) where ΔSₘ is the entropy of migration, but only represented as a one-body problem. In the framework of a many-body picture, ΔSₘ is predicted to be dependent on the vibrations of the host sublattice as shown in eq. 6.⁷

$$Δ {S}_{m} = {k}_{B} ln [ \frac{{\prod }_{i = 1}^{3 N - 1} {v}_{i}^{I}}{{\prod }_{i = 1}^{3 N - 1} {v}_{i}^{S}} ] . \qquad 6$$

The transition state vibrational frequencies (vᵢ^{s}) belong to the entire system at the starting point of the transition. The initial state vibrational frequencies (vᵢ^{l}) consists of the normal frequencies of the system constrained in the saddle point configuration, thus requiring a many-body treatment.^{15,17} If vᵢ^{s} is sufficiently large, like in the case of ion conductors with large anharmonicities and soft anion sub-lattices, ΔSₘ and the subsequent σ will be large, rendering it essential for studying phonon-coupled conduction.

Although eq. 6 theoretically predicts the relevance of ΔSₘ on σ, researchers have yet to quantify the role of ΔSₘ experimentally. To prove the relevance of many body-couplings on ion migration, we experimentally drive correlated polyanion motions and measure the resulting effect on o and compare this result to driving other acoustic and optical phonon modes. While driving structure modes to change electronic and magnetic properties is common in condensed matter materials,^{16,23,24} the techniques^{25, 26} have not been applied to determining conductivity or impedance from one or more second frequencies tuned to drive hopping of ions between ion sites in the sample and one or more first frequencies tuned to drive excitations in the sample that interact with the ions as described herein.

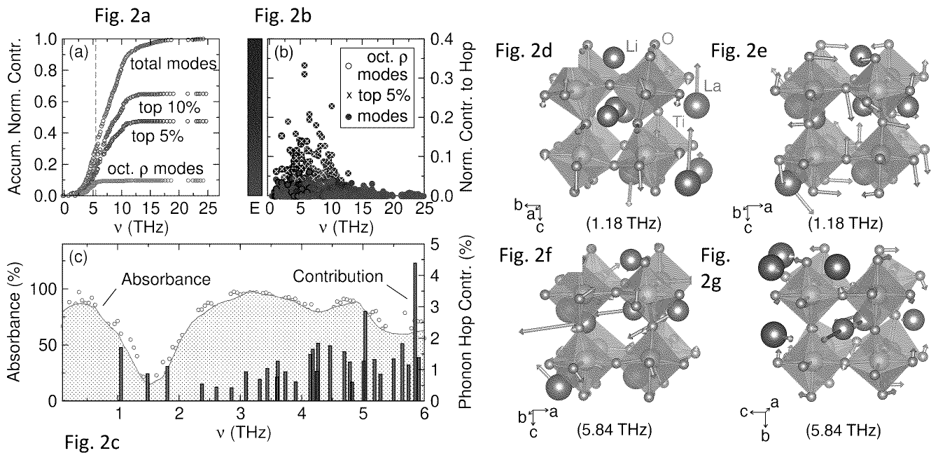

Using ab initio calculations, the contribution to ion hopping in LLTO is modeled based on 22 unique Li-ion hops across three types of LLTO orderings and structural information from experimental synchrotron diffraction data. By considering all types of ordering, all possible ion migration pathways and types of phonon vibrations can be analyzed. FIG. 2a shows the total accumulative normalized contribution to ion hopping across 0-27 THz. When the total modes are further disaggregated by top contributions, 10% of the highest contributing modes cause 61% of the contributions to ion hopping, and 5% of the highest contributing modes cause 48% of the contributions. Below 6 THz, it is found that 36% of modes are rocking in nature and have a 50% contribution to ion hopping.

The amount of energy that an individual phonon imposes on a hopping Li-ion is also calculated. Although low THz frequency modes should naturally be high in energy, the energy of these modes are frequency independent. In classical thermodynamics, the distribution function for the number of phonons at a specific frequency ω is k_{B}T/ℏω. If the total energy of the phonons at a given frequency is determined, and the energy of each phonon is ℏω, then the total energy E is k_{B}T, becoming frequency independent. Thus, at lower frequencies, there are many low energy phonon modes and several high energy phonon modes that sum to an overall high energy.

FIG. 2b plots the energy the phonon mode imparts on the hopping ion, represented by a color gradient, vs. its corresponding phonon frequency. FIG. 2b shows that high energy phonon modes are also present in addition to rocking modes below 6 THz, with percent contributions for both mode types shown in more detail in FIG. 2c. It is calculated that within the top 5% of highly contributing modes below 6 THz, >95% are rocking modes, high energy phonon modes, or a combination of both. Thus, to promote ion transport, the surrounding polyanions must (1) have sufficient energy to transfer to the Li-ion along the correct hopping direction and (2) have the right vibration that opens the bottleneck for ion migration. Both conditions are not met for modes shown in FIG. 2d-f but are fulfilled by those in FIG. 2g. Thus, after confirming that there are modes that fulfill conditions (1) and (2) within the experimental THz range described herein, the inventors hypothesize that exciting these highly contributing mode types should lead to improved ion transport in LLTO.

b. Spectroscopy Measurements

### (i) Sample Holder

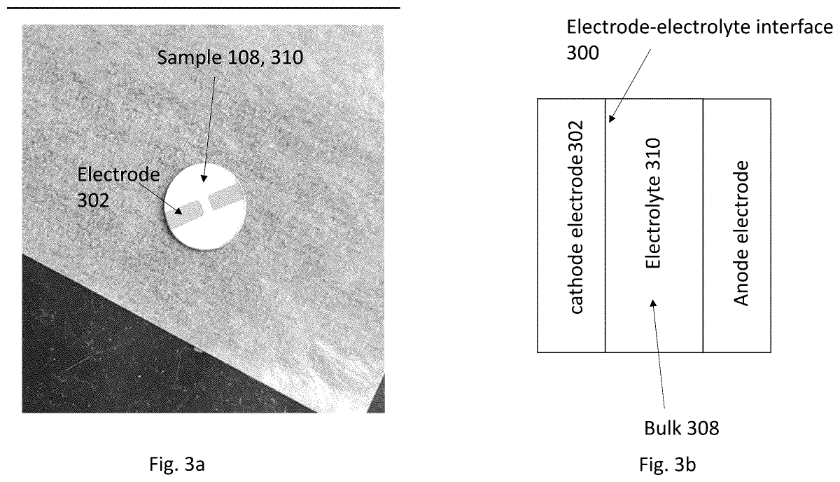

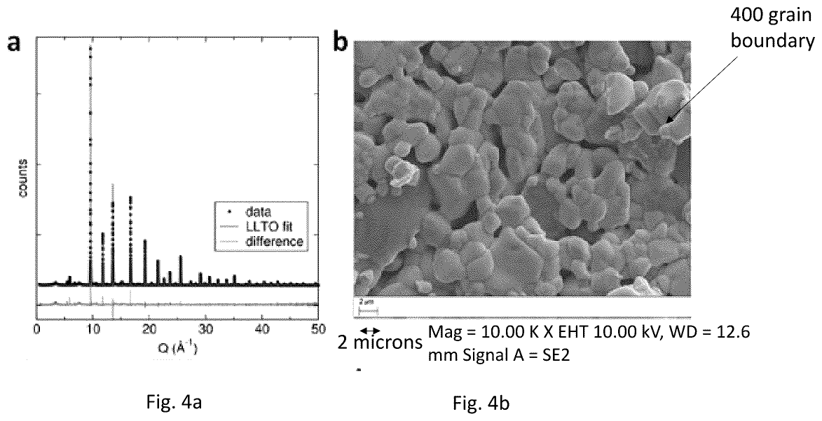

FIG. 3 illustrates a sample holder used for battery cell testing. A heating cell allowed temperatures between 298 K-333 K for reference measurements of incoherently heating the phonon bath, as performed for standard impedance testing. A polymethylpentene (TPX) optical window was integrated into the heating cell to allow transmission of the THz field. For other visible/UV light sources, a quartz window that is transparent between 190 nm-2500 nm was used. Measurements without a window for non-air and moisture sensitive samples were also performed.

### (ii) Sample Preparation

Lithium lanthanum titanate (Li0.5La0.5TiO3, LLTO) was used as a test sample because it is stable. The LLTO was synthesized according to literature¹: stoichiometric amount of La₂O3, Li2CO3 and TiO₂ were mixed in an agate mortar and pressed into pellets under 100 MPa of pressure. The pellets were placed on a bed of sacrificial powder and calcined at 800° C. for 4 h then 1200° C. for 12 h at a ramp rate of 1° C./min. The resulting powder was pressed into a pellet with a diameter of 10 mm and a thickness of 0.6-0.8 mm under 2 tons of pressure. The pellet was subsequently annealed at 1100° C. for 6 h at a ramp rate of 2° C./min over a bed of its mother powder. A 1.6 mm strip of Au was sputtered onto one side.

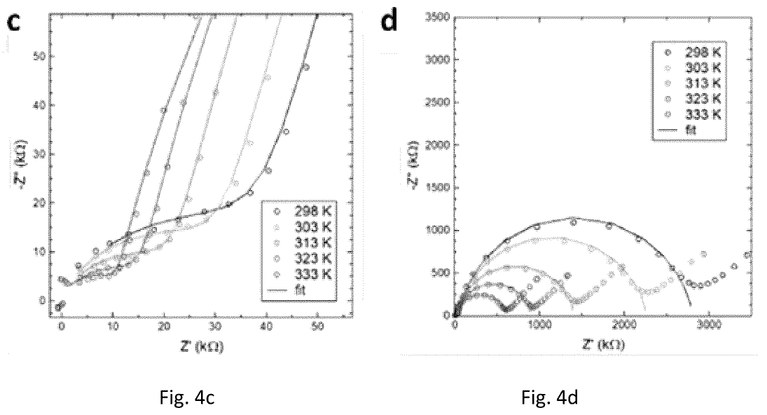

FIGS. 4a-b shows the XRD pattern, the 1-10 μm grain size.

(iii) Equipment

The laser-driven ultrafast impedance spectrometer illustrated in FIG. 1 was constructed using a signal generator (100 GHz, Keysight, N5173B) and a high-speed oscilloscope (100 GHz, Keysight, N100A/N1046A). Performances of a real-time and sampling oscilloscope were compared with no discernable difference because the jitter of the output of the laser is less than that of the oscilloscope. Thus, either type of oscilloscope can be used.

The bandwidth of the signal generator and oscilloscope determines the temporal and frequency resolution. It is desirable to use a signal generator and oscilloscope with a low noise floor because this determines the lowest differential signal that can be measured. Noise floors of 10⁻⁴ were possible using the signal generator and oscilloscopes.

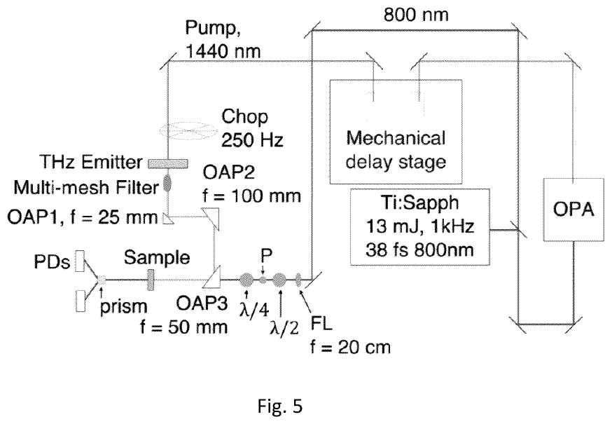

FIG. 5 illustrates laser set up for the THz, NIR, and MIR generation. A Ti: Sapphire laser oscillator and amplifier (Legend Elite) from Coherent were used to create the UV to THz light. Specifically, UV to NIR light is created using an optical parametric amplifier (TOPAS) from Light Conversion. Difference frequency generation was used to cover the 5 to 15 μm range. THz light was generated using a DAST and the 1400 nm output of the optical parametric amplifier. Average powers were in the few mW for the 1 KHz laser and focused into a few hundred micrometer spot size.

The signal generator, oscilloscope, and laser were synchronized by frequency dividing the laser oscillator output (80 MHz) signal to 10 MHz. The light from the laser is focused between a surface gap electrode. The signal was recorded on the oscilloscope, referenced against the output of the signal generator. A picosecond rise time photodiode measuring the output of the 1 kHz laser amplifier was used as the oscilloscope trigger to locate the picosecond impedance modulation. The impedance change itself was then used as the trigger once the time window has been narrowed down. The measurement was then be repeated for multiple laser excitation frequencies or multiple signal generator frequencies. Bulk site-to-site hopping and grain boundary frequencies were determined beforehand using a static impedance measurement (FIGS. 4c-d).

### (iv) Time Resolved Measurements

Li⁺ conduction in LLTO is mediated by adjacent vacancies in between bottlenecks formed by four oxygens from four corner shared TiO₆ octahedra. Screening effects have been predicted to aid ionic conduction by minimizing electrostatic interactions between the host lattice and migrating ion, enabling fast ion migration for several solid-state Li⁺ and O₂²⁻ conductor. In LLTO, a ligand-to-metal charge transfer transition can occur upon the 2.1 eV band gap excitation which promote electronic carriers from the O 2p orbitals to the Ti 3d orbitals. By transferring charge density from the O 2p orbitals to the Ti 3d orbitals, the electrostatic hindrance in the ion conduction pathway is likely reduced, giving insight into the ion-electron interactions.

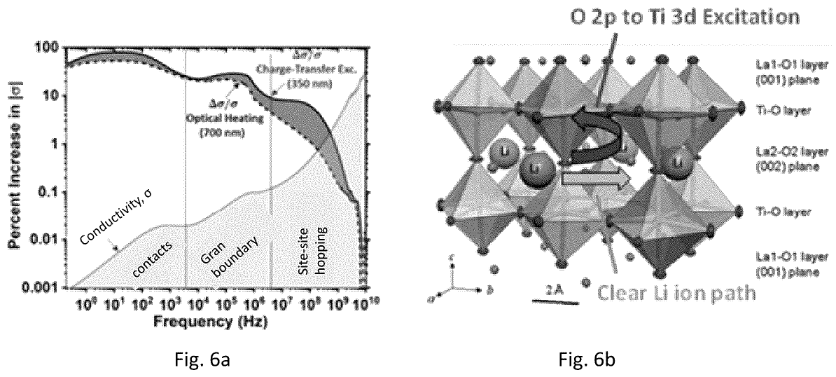

FIG. 6c shows a timeresolved ultrafast impedance measurement taken using the highspeed oscilloscope and an above band gap pulsed laser excitation. A clear time-resolved change in the ionic conductivity is measured once the AC carrier frequency is removed using a Fourier filter. The 350 nm photoexcitation causes a charge transfer transition from the O 2p orbitals to the Ti 3d orbitals. As noted above, ion conduction in LLTO is theorized to occur by rocking modes promoting ion hops between vacant sites of the TiO₆ octahedra (FIG. 6b). By transferring charge density from the O 2p orbitals to the Ti 3d orbitals, the electrostatic hindrance in the ion conduction pathway is reduced and an increase in ionic conductivity is measured.

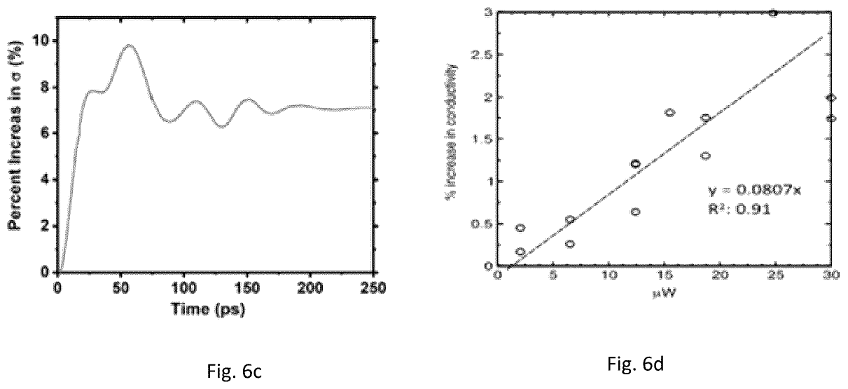

FIG. 6a shows the change in impedance after photoexcitation of the LLTO repeated from the Hz to tens of GHz region as compared to just laser heating of the incoherent phonon bath. FIG. 6a used a CW laser to allow the wide-frequency AC impedance sweep but the percent change in impedance is still the same. The red area in FIG. 6a shows the difference between laser heating and the charge transfer transition. As expected, the largest increase in ionic conductivity is in the site-to-site hopping region since the shift in charge density lowers the activation energy for the ion hop. Changes are also measured in the grain boundary and contact regions but are not as significant. The changes in the measured impedance were linear in power and linear with respect to the laser beam size relative to the gap electrode distance (FIG. 7d). The impedance changes above 10 GHz were noisier due to the gap electrode distance but could be improved with sample optimization.

Using a single excitation or driving frequency and measuring the change in the AC impedance gives information on two-particle like interaction terms, i.e. ion-phonon and ion-electron interactions. By using a two-pulse excitation scheme, similar to 2D spectroscopy, the many-body cross correlations like ion-electron-phonon or ion-phonon-phonon could be measured with ion-ion correlations determined by cross-peaks in the 2D spectrum and comparison of the resulting relaxation dynamics between pulses. Ultimately, this form of the instrument would allow for a near complete measurement of the ion hopping Hamiltonian just as 2D spectroscopy has been used in other light or IR active systems.

### (v) Non-Time Resolved Experiment

The non-time resolved adaptation of the technique was tested for comparison. An off the shelf impedance analyzer was used that could measure up to 32 MHz; right at the edge of the siteto-site hopping regime for LLTO. A continuous wave (CW) light source is coupled to a 1260 A Solartron impedance analyzer to measure changes in the complex impedance between 1 Hz to 32 MHz, encompassing grain boundary and the tail of the bulk conduction regimes in many materials. While ideally a CW light source would be used to excite the sample from the UV to THz, a Ti: Sapphire laser and nonlinear frequency mixing was used for the data here to access this regime with high power.

FIG. 7 schematically illustrates the laser-driven impedance technique using THz irradiation and EIS to measure the relative role of coupled ion-phonon vibrational modes on the overall ion conduction process in Li_{0.5}La_{0.5}TiO₃ (LLTO). The effect of driving the THz p modes in Li_{0.5}La_{0.5}TiO₃ (LLTO) was also measured as compared to acoustic and optical phonons across the near-IR (NIR) and mid-IR (MIR).

### (i) Normalization

Given the pulsed laser's 1 kHz repetition rate, the data is duty-cycle averaged (the 1 kHz repetition rate means that any measured dynamics are time averaged) and a thermalized value must be obtained, lowering sensitivity. Several normalization parameters including incident power, power density, and penetration depth of each wavelength were carefully considered. However, ultimately, a normalization of the change in the impedance per change in temperature of the sample was used. This method normalizes the total absorbed power independent of the strength of the transition, and since the measurement is taken in equilibrium after several minutes, also the penetration depth relative to the surface electrode. Direct comparison between the different excitation wavelengths and DC heating, like from a furnace which incoherently excites the phonon bath, is therefore possible.

The normalized impedance per change in heat accounts for the total absorbed power independent of the strength of a transition. Since the complex impedance measurements were taken at equilibrium after several minutes, the penetration depth relative to the surface electrode is factored into the final value. Thus, the normalization methodology allows for direct comparison between the laser heating and DC heating to accurately calibrate the data baseline.

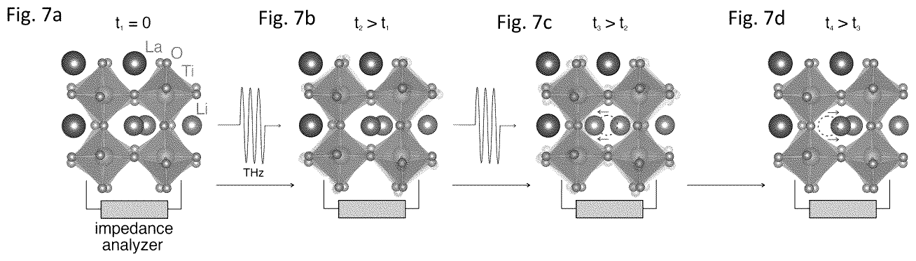

The normalization was accomplished by first constructing a calibration curve with the custom heating cell shown in FIG. 8 using a TC-48-20 OEM temperature controller and thermocouple. The current and voltage that is measured across the cell and through the sample is used to calculate the power input into the sample based on Watt's law P=IV. By plotting the calculated P versus the temperature read out from the TC-48-20 OEM software, a calibration curve was built to determine a temperature associated with a power input into LLTO. The normalization approach was found to give similar percent changes as normalizing by power density, proving the validity of the proposed method. Thus despite the experimental limitations between using the CW and pulsed laser excitations to accurately interpret the data, nontime resolved measurements with the commercial impedance analyzer can be accomplished and still provide valuable information on coupling dynamics in a variety of solid-state materials without needing custom electronics.

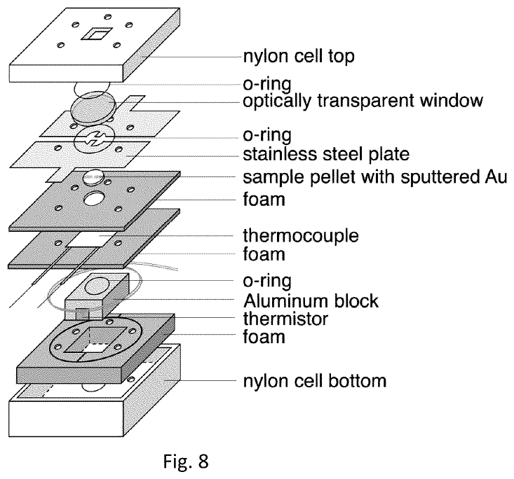

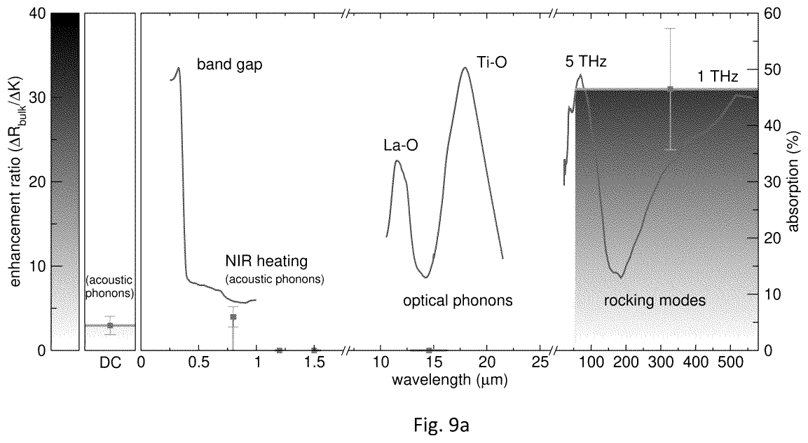

For the non-time resolved measurements up to 32 MHz frequencies, the custom cell was constructed with a ceramic heating plate with temperature-controlled operation using the corresponding software from the TC-4820 OEM heater and thermistor, as shown in FIG. 9a. The heating cell was placed inside a faraday cage made of copper mesh with a 1.4 mm wire spacing for all experiments to reduce noise from electromagnetic interference. A THz transparent window can be designed with a variety of organic materials and crystalline materials 66. For the other visible/UV light sources, a quartz window that is transparent between 190 nm-2500 nm is used. A windowless set up can alternatively be employed for non-air sensitive materials. The sample itself was annealed and densified as described above, and a blocking electrode, such as Au, Ag, Pt, or Pd, was sputtered onto the pellet with a mask to create a gap-electrode geometry. Sputtering Au electrodes on the same plane of the sample pellet with a gap geometry shown in FIG. 8, rather than fully sputtering both planes, minimizes the volume of sample that is probed during the impedance measurement, rendering the effect of differences caused by optical penetration depth and spot size to be more negligible. Thin film samples can also be used so that optical penetration depths are negligible. The developed in plane electrode configuration is compatible with the time resolved set up and can also test grain boundary and bulk conduction effects, with grain boundary contributions dominating the overall ionic conductivity when used as solid electrolytes in all solid-state batteries.

### (ii) Results

FIG. 9a compares the change in impedance for the grain boundary feature of LLTO over a range of excitation frequencies. For the 32 MHz frequency range, the grain boundary and tail of the bulk ion hopping conduction regimes showed identical trends, as expected from FIG. 4a. The relevant absorption features for each sub-system is shown as the colored curves in FIG. 9a. The bar chart height then represents the enhancement ratio of the bulk impedance after laser driving at that frequency while the width of the bar represents the bandwidth of the excitation source for that frequency. The UV excitation changes electrostatic blocking in the lattice cage by a ligand to-metal charge transfer from the O 2p valence band orbitals to the Ti 3d conduction band orbitals. The THz excitation represents a range of TiO₆ rocking modes and proves to be the dominant term in changing the bulk ion hopping. The NIR and DC heating plots serve as the control data since they incoherently heat the material mainly through the acoustic phonon bath. A signal was not detected for photoexciting the optical phonon branches with similar powers as the THz rocking modes, but a higher power DFG unit would provide more definitive evidence.

With the THz light, a 0.7% ΔR_{bulk}/mW was measured which was calculated to be a 31% decrease in ΔR_{bulk}/K. Incoherently heating the acoustic phonon bath with the 800 nm light yields a 0.12% change in ΔR_{bulk}/mW or an estimated 4% change in ΔR_{bulk}/K. This change was comparable to the 0.07% change in ΔR_{bulk}/mW or 3% change in ΔR_{bulk}/K from DC heating, within error, proving that laser heating of the lattice alone is not responsible for the observed changes caused by THz light. No detectable change was measured for frequencies across the optical phonon range for the same power densities used to drive the THz phonons. The MIR power was an order of magnitude lower than the power for thermal heating, so the relative role can only be bound in this range. The result, however, is consistent with the theoretical prediction that modes above 10 THz (˜30 μm) are less likely to contribute to ion hopping.

Two comparisons can be made to test the accuracy of the duty-cycle averaged version of the instrument. First, the relative change between the DC or NIR heating and the 350 nm photoexcitation is 5 times for both CW excitation in FIG. 4a and duty-cycled averaging in FIG. 9a. Second, The THz excitation can be integrated over the theoretically predicted contribution to ion hopping (FIG. 9b). Using a simple Boltzmann distribution approximation and the theoretically predicted phonon mode contributions, the combined 1-6THz modes would account only for ˜2% of the ionic conduction at room temperature. When driven directly by the THz excitation, the contributions of the THZ rocking modes become ˜30%. The ratio of these two numbers matches the ˜15× enhancement in ionic conductivity measured in FIG. 9a.

More specifically, after the approximated normalization between driving wavelengths from NIR to THz light, the measurements confirmed that selectively exciting the THz p mode leads to an order of magnitude decrease in R_{bulk} and R_{gb} compared to non-resonantly heating the acoustic phonon bath or resonantly driving the optical vibrational modes. This is reminiscent of photo-modulated ferroelectricity, magnetism, and ionic conductivity in inorganic-organic perovskites—the enhancement is persistent and reversible, even though the recorded changes are averaged over the 500 Hz repetition rate of the laser.

FIG. 9a therefore accurately measured the relative contribution of a sub-system of the ion hopping Hamiltonian relevant to incoherent heating, and using this normalization metric, a relative comparison between different ion hopping Hamiltonian components. For example, FIG. 9a shows that the THz rocking mode is clearly the dominant vibrational mode in as compared to optical phonons or the rest of the acoustic phonon bath. Second, the UV excitation confirms that a significant electrostatic hindrance to the ion hopping through the lattice cage exists. When LLTO is doped or compared to LLZO to reduce the electrostatic hindrance, it is known from literature that increases in ionic conduction are achieved. The simpler version of the experiment should therefore be particularly powerful when comparing materials optimization strategies as a relative measurement.

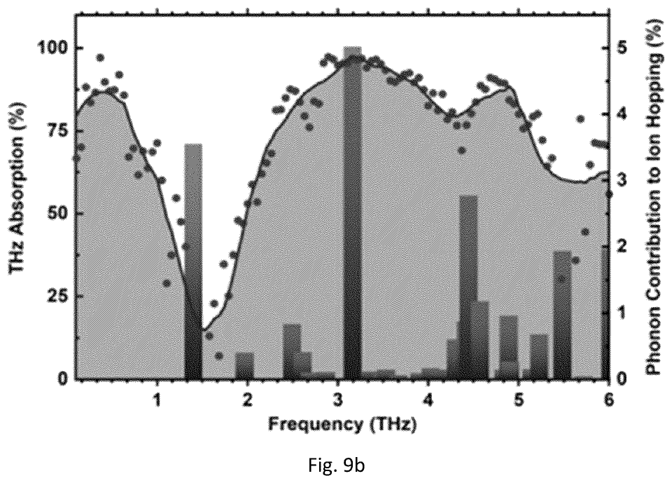

The Nyquist plots for LLTO with no laser excitation are shown in FIGS. 10a and 10b and illustrated in FIG. 7a. The impedance data for the bulk and grain boundary impedance are fit separately to an R1+R2/Q2 circuit. With increasing temperature, we measure a shift toward lower impedances for Z′ and Z′, corresponding to the increase in population and mode types in the phonon bath. The E_{A} for migration is therefore lower and the v₀ for Li-ion hopping is higher, thus the measured decreased in Z′. The semicircle fit corresponding to the grain boundary contribution has a different shape than the bulk contribution, likely because the bulk semi-circle partially overlaps with the grain boundary feature. We find that this varies slightly from sample to sample, but the final impedance difference is consistent between all measurements within error.

FIG. 10c-10d shows a linear change in the Z′ is measured for both the bulk and grain boundary features with respect to power when driven with broadband THz radiation (measured absorption of LLTO shown as the shaded area in FIG. 2c). The change is reversible, reverting to the pre-illumination impedance after illumination (FIG. 7d). Before normalization, the change in Z′ is on the order of 100s of Ω for an average THz power in milliwatts. After normalization, the change in R_{bulk} can be compared to other optical phonon modes in the MIR and acoustic phonon modes excited incoherently by laser of DC heating.

The relative decrease in R_{bulk} with THz light (of about 10× compared to incoherent DC heating) proves the hypothesis that resonantly driving highly contributing phonon-ion coupled modes can promote ion migration. The enhancement is in-line with integrating the contributing modes over the THz excitation range and comparing it to the thermal regime. For DC or laser-induced heating, the same power was incoherently spread across a variety of acoustic and higher energy phonon modes, so the overall change in the measured Z′ is lower. Additionally, it is unlikely that the THz fields add any electronic contribution toward the total, measured conductivity or excite any electronic carriers in LLTO. THz energies are generally <1 eV with this study being <0.025,³⁵ which is sufficiently below the 2.1 eV band gap of LLTO.³⁶ Therefore, it is unlikely that the THz fields can generate electronic carriers or have sufficient energies to promote enhanced electronic conductivities like in the case of materials with known superconducting transitions.²⁴

This study can be used to clarify the role of ΔSₘ in eq. 6 and measurable variables that can change ΔSₘ. Selectively driving different phonon mode types with narrow-band THz pulses would be instrumental in further decoupling the ion migration dynamics caused by high energy phonon modes versus those that only distort the vibrations of local polyanions.³⁷

It is important to note that for both the THz excitation and non-resonant heating, it takes approximately 100 seconds for the decreased impedance to equilibrate and relax, as represented in FIG. 7d. The matching rise and decay times indicate that the THz decreased impedance exists on a much longer timescale than the picoseconds timescale of the THz driving force itself. The matching thermal and THz equilibration times, but non-matching changes in impedance, hint that driving the coupled phonon-ion THz modes might create a nonequilibrium Li ion pathway that then equilibrates through thermal vibrations. Further experiments are needed to clarify this aspect of the conclusions.

These results demonstrate that laser driving can be used to control the ion-phonon states and the many-body correlations that lead to fast ion transport in a solid. Moreover, the spectroscopic technique can roughly determine the relative contribution of different vibrational modes to macroscopic ion hopping. By separating the relative contributions, the design of solid electrolytes can be improved by targeting key contributing modes

In other embodiments, the non-time resolved measurement can use a CW source (e.g., a lamp or incoherent light source) and the same normalization data. High power lamp and monochromator combinations are commonly used in various action spectroscopy say for solar energy materials. This form of the instrument would represent a straightforward approach that could be implemented without the need for specialized optics knowledge or the cost of an ultrafast laser. Reaching the important far-IR to THz range with sufficient power is more difficult and may in some embodiments require a laser source.

### 4. Second Example: S11 Reflection Measurements with SMA Connection and Vertical Launch Connector

a. Sample Holder and Sample Preparation

LLTO was synthesized according to literature⁵⁹ and characterized and tested as mentioned in previous work³⁸

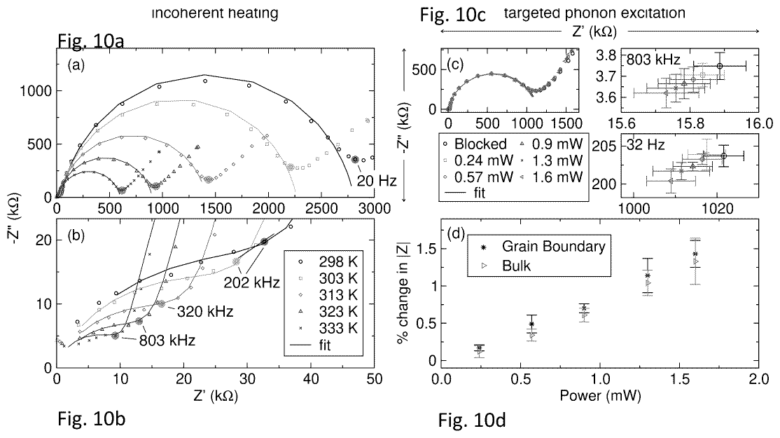

For S11 reflection measurements, the vector network analyzer (VNA) generates an AC signal that transmits to the sample, or load, via a directional coupler with an SMA connection into the sample and a copper short at port S12 modeled from previous literature^{55,57,58} as shown in FIGS. 11a and 11b. A 2 mm wide cavity is drilled out from the side of the copper short to allow laser excitation during the time-resolved measurements. The powder sample is densified into a ¼″ diameter pellet under high force (2 tons), annealed to achieve at least 80% of its theoretical density (specific to the composition), and subsequently sanded to fit inside the 300 micron well. In addition to minimizing air gaps, the sample needs to make physical contact with the pin inside of the vertical launch connector to create a resonator, which is critical for accurate measurements, as shown in FIGS. 3a and 3b. The S11 port which measures the reflected wave and the S13 port which provides the coupled reference wave are connected back to the VNA as shown in FIG. 11c. To physically measure the S11 parameter, microstrips, or metallic strips are deposited or contacted onto the sample load to enable high frequency transmission from hundreds of MHz to over 10 GHz⁵⁶. The electrical connection between the microstrip and the oscilloscope is established with a co-axial cable with appropriate adapters rated for GHz frequencies, such as SMA connections.

To measure the time-resolved impedance signal, a 40 GHz, Keysight, N5173B signal generator coupled with a 40 GHz, Keysight, N100A/N1046A oscilloscope is used. Experimentally, 130 mW of average power is used for the 1 kHz laser depending on the sample and focused into a beam of 200-300 microns in diameter.

The laser clock can be used as an external reference to sync with the custom VNA, but in some cases, syncing can be difficult as many signal generators only accept a 10 MHz reference signal that a laser clock will not output and the laser clocks output, even after frequency dividing, may not have sufficient phase stability. An IQ demodulation approach is therefore preferable to extract amplitude and phase data with a picosecond photodiode used to help locate the transient signal. Next, the S11 measurement is conducted for multiple laser excitation frequencies or multiple signal generator frequencies, depending on the experiment.

b. Steady State Measurements

A 2 Hz-110 GHz Keysight N9041B UXA Signal Analyzer was employed as a VNA for steady-state measurements.

Li⁺ conduction in LLTO is mediated by adjacent vacancies in between bottlenecks formed by four oxygens from four corner shared TiO₆ octahedra^{60,62}. Screening effects have been predicted to aid ionic conduction by minimizing electrostatic interactions between the host lattice and migrating ion, enabling fast ion migration for several solid-state Li⁺ and O₂²⁻ conductors^{17-19,34}. In LLTO, a ligand-to-metal charge transfer transition can occur upon the 2.1 eV band gap excitation which promote electronic carriers from the O2p orbitals to the Ti3 d orbitals⁶¹. By transferring charge density from the O2p orbitals to the Ti 3 d orbitals, the electrostatic hindrance in the ion conduction pathway is likely reduced, giving insight into the ion-electron interactions.

To test the role of screening on ionic conduction, the bandgap of LLTO is optically excited through the cavity accessing the LLTO sample in the vertical launch geometry shown in FIG. 10. Although the application of the vertical launch geometry was suitable enough for proof-ofconcept measurements, noise above 10 GHz was observed, potentially due to contact issues and pellet density. Further optimization of the cell design would enhance the signal to noise ratio in future studies.

The 2 Hz-110 GHz Keysight N9041B UXA Signal Analyzer was initially used to perform steady state measurements of LLTO upon 350 nm and 700 nm excitation to explore the concept capabilities of the instrument before the more complicated time-resolved experiments. Note that a vector network analyzer (VNA) is, at its essence, a coupled signal generator and oscilloscope so the time resolved electronics outlined can also be used for this step. The S11 signal is Fourier-filtered to remove the carrier signal frequencies and is used to calculate Z_{L} using Eq. 3.1-3.3. The Z_{L} can then be used to calculate the ionic conductivity using the equation

$$σ = \frac{l}{{R}_{tota {*}^{* A}}}$$

where σ is the ionic conductivity, Rₜₒₜₐₗ is the impedance that is treated as Z_{L}, 1 is the sample thickness, and A is the sample area.

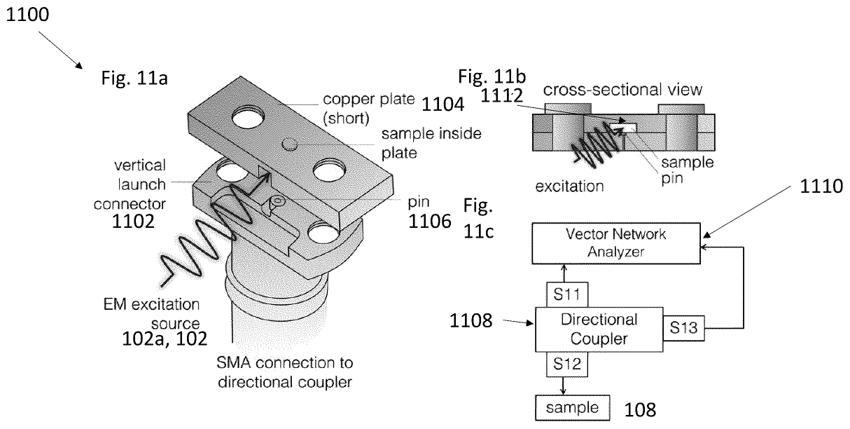

The steady-state response was first measured and used to calculate and plot Δσ/σ as a function of frequency as shown in FIG. 12. The plot shows the enhancement in conductivity of LLTO after photoexcitation with a 350 nm CW laser. The shaded red region in FIG. 12 shows the difference in the changed ionic conductivity due to laser heating of the incoherent phonon bath with 700 nm light versus the modulated Li⁺-electron coupling from the 350 nm bandgap excitation. The largest increase in the enhancement ratio is observed in the site-to-site hopping region and is likely due to the shift in charge density from the O2p to Ti 3 d orbitals which we predict to lower the activation energy for the ion hop. The differences observed due to the 350 nm and 700 nm at the grain boundary and across the electrode-electrolyte surface regions is also observed and are likely related to the population of thermal baths.

Although the generation of electronic carriers can convolute the final Li⁺ mobility values typically determined through impedance methods like EIS, many reports suggest that enhancements in ion migration are not exclusively due to the newly generated electronic carriers¹⁷⁻¹⁹. Thus, we believe our observations of enhanced ion migration due to this charge transfer process holds, after accounting for heat generation and electronic carrier generation. Even if electronic conduction effects are also present, the experiments described still prove the general concept of the instrument in its steady-state implementation.

c. Time-Resolved Measurements with Custom VNA

The custom, time-resolved version of the VNA comprising the 40 GHz signal generator and oscilloscope was used to measure the time resolved enhancement in ionic conduction in LLTO due to band gap excitation. The sample cell configuration shown in FIG. 3 is used to conduct the measurement.

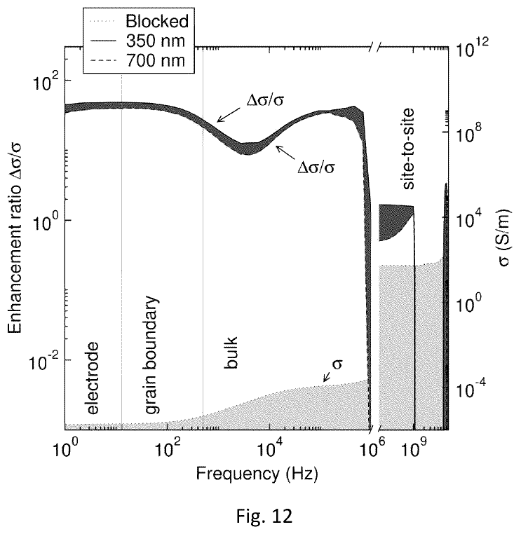

FIG. 13 shows the enhancement ratio Δσ/σ as a function of frequency in the time resolved configuration using the custom VNA up to 300 picoseconds. The enhancement observed in FIG. 13 between 0 and 60 picoseconds is due to the laser impulse changing the electronic screening experienced by the Li⁺. The enhancement ratio after 60 picoseconds decays because of the absence of the 30-femtosecond ultrafast pulse. FIG. 12 could be constructed completely of time-domain traces like in FIG. 13 through automation, but as demonstrated here, it is often useful to use a wide frequency range impedance measurement first in a non-time resolved manner to determine the region of interest.

The time resolved data at the picosecond timescale gives insight to how site-to-site hopping is influenced by screening at the local scale which has, to our knowledge, never been demonstrated previously, and would expand existing knowledge on how the unique local structure of hopping channels collectively influence ionic conduction.

d. Non-Time Resolved Laser Driven Impedance Using a Commercial Impedance Analyzer

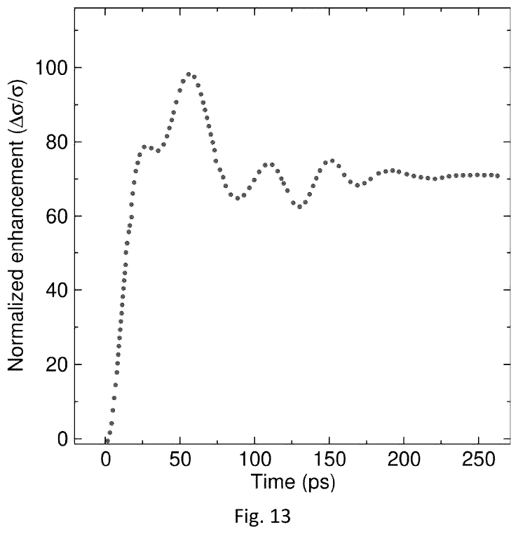

The change in impedance caused by UV-excitation described above in the time resolved case is demonstrated again here with the non-time resolved methodology, shown in FIG. 14. The equivalent circuit fit for the bulk conduction feature (FIG. 14a) and grain boundary feature (FIG. 7b) is shown along with the corresponding Nyquist plots, demonstrating good agreement. The R values corresponding to the grain boundary and bulk hopping regimes (R_{GB} and R_{Bulk} respectively) are assigned based on capacitance values obtained from the circuit fit. The final R_{GB} and R_{Bulk} extracted from the fit is plotted against UUV power in FIG. 14c-e, demonstrating that the measured change in impedance is linearly proportional to power. The sequential shift towards decreased impedance upon increasing UV light average power indicates that screening effects promoting facile ion conduction, mirroring the results described previously in Section II.

As noted in the first example, lamps and incoherent light sources could be used instead without the need for specialized optics knowledge or the cost of an ultrafast laser, given the sample is normalized by heat as demonstrated in FIG. 7b. Photo-modulated spectroscopy has been adopted for many applications including fast charging in batteries³⁵ and modulating ion hopping^{34,41}, and it is believed the measurements described herein can be adopted to investigate charge transport systems.

Specifically, the differences in the enhancement ratio values between the hopping time regimes across a broad range of frequencies shows how each regime can behave quite differently and how the use of spectroscopy described herein can be used to explore the unique couplings that have been predicted to influence ion migration. By comparing the relative enhancement ratios at different hopping regimes due to a series of targeted ion-phonon, ion-electron, and ion-ion excitations, couplings that dominate the ion conduction mechanism and pave the way for targeted design of superionic conductors can be revealed.

### Device and Method Embodiments

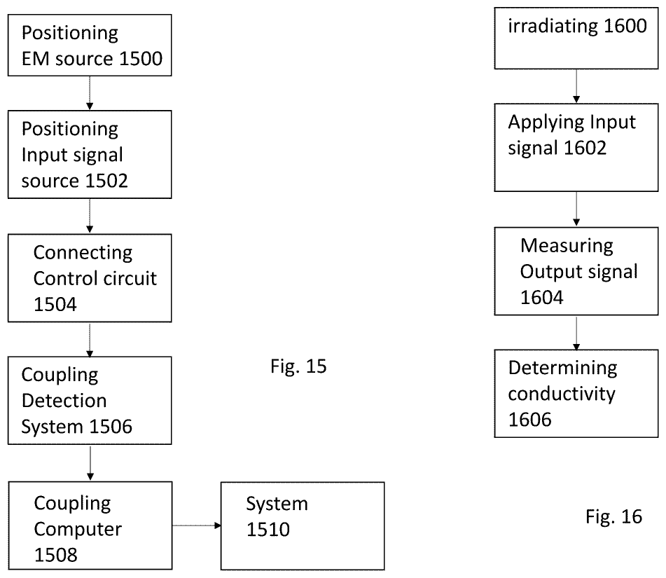

FIG. 16 illustrates a method of making a spectrometer system, comprising positioning a source of the electromagnetic radiation (Block 1500), coupling the source of the input signal (Block 1502); connecting a control circuit (Block 1504); connecting a detection system (Block 1506; and connecting a computer (Block 1508).

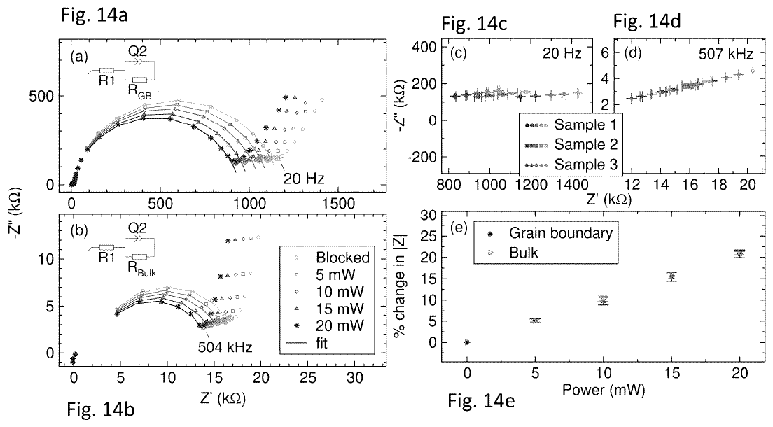

Illustrative embodiments of the device, system, or apparatus (Block 1510) manufactured according to the methods described herein (or other methods) include, but are not limited to, the following (referring also to FIGS. 1-18).

1. A spectrometer 100 (or an apparatus, system, or device useful for performing spectroscopy), comprising:
a source 102 of electromagnetic radiation 102a comprising one or more first frequencies;
a source 104 of an input signal 104a comprising an alternating (AC) electric field comprising one or more second frequencies;
a control circuit 106, 1700 operably connected to the sources 102, 104 for synchronizing (or configured to, configurable to, and/or programmable to synchronize) application of the electromagnetic radiation and the AC electric field applied to a sample, so that an output signal (e.g, an AC signal, e.g., comprising an electric field or voltage signal) comprising a modulation of the AC electric field is outputted from the sample in response to:
the one or more second frequencies tuned to drive hopping of ions between ion sites in the sample, and
the one or more first frequencies tuned to drive excitations in the sample that interact with the ions;
a detection system 112, 1914 operably connected to the sample holder for the sample, or positioned for, measuring and/or detecting (or configured to measure and/or detect) a change in the output signal in response to the electromagnetic radiation; and
a computer 114, 1700 operably connected to the detection system for determining (or configured/programmed to determine) at least one of a conductivity or impedance of the sample from the output signal and as a function of the first frequencies and the second frequencies.

2 The spectrometer of embodiment 1, wherein the control circuit 106 controls or is configured to control, or further comprising a control circuit for controlling:
a sweep of the first frequencies over a first range to drive the excitations of electrons, ions, and/or phonons in the sample 108 comprising an electrolyte, and
a sweep of the second frequencies over a second range such that the input signal drives ion hopping in the electrolyte over a variety of ion migration time-scales.

3. The spectrometer of embodiment 1 or 2, wherein the computer 114 determines or is configured/programmed to determine the change in the conductivity at one or more of the second frequencies associated with the migration time-scales in different ion hopping regions in the electrolyte 310 including a contact region 300, a grain boundary 400, and a bulk 308 region.

4. The spectrometer of any of the embodiments 1-3, wherein the electrolyte 310 comprises a solid electrolyte for a battery.

5. The spectrometer of any of the embodiments 1-4, wherein the sample comprises electrical contacts to the solid electrolyte comprising lithium ions for a lithium ion battery.

6. The spectrometer of any of the embodiments 1-5, wherein computer determines (or is configured/programmed to determine), from the output signal, a Hamiltonian for the sample describing the interaction between the excitations excited by the electromagnetic radiation and the hopping driven by the input signal.

7. The spectrometer of any of the embodiments 1-6, wherein the source of electromagnetic radiation comprises a pulsed or continuous wave (CW) laser 118 outputting the first frequencies in a range between ultraviolet (UV) frequencies and terahertz (THz) (e.g., but not limited to, frequencies corresponding to a wavelength 100 nanometers≤wavelength≤3 millimeters).

8 The spectrometer of any of the embodiments 1-7, wherein the source of electromagnetic radiation comprises a lamp outputting the electromagnetic radiation.

9. The spectrometer of any of the embodiments 1-8, wherein the source of the input signal comprises a signal generator 120, e.g., outputting the second frequencies f1 in a range of from 1 hertz (Hz) to 1 terahertz (THz) or 1 Hz to 100 gigahertz (GHz) (1 Hz≤f2≤100 GHz or 1 Hz≤f≤100 THz).

10. The spectrometer of any of the embodiments 1-9, wherein the detection system measures, or is configured to measure, the change or the conductivity on a timescale of the excitations driven by the electromagnetic radiation.

11. The spectrometer of any of the embodiments 1-10, wherein the source of electromagnetic radiation comprises a pulsed laser outputting, or configured to output, pulses of the electromagnetic radiation having a full width at half maximum (FWHM) of 10 picoseconds (ps) or less in a range of (e.g., 1 femtosecond (fs)-1 nanosecond (ns) or 1 fs-10 ps, e.g., 1 fs≤FWHM≤1 ns or 1 fs≤FWHM≤10 ps) and the detection system measures the changes in the conductivity with a time resolution of the envelope of the FWHM.

12. The spectrometer of any of the embodiments 1-11, wherein the first frequencies comprise terahertz frequencies.

13. The spectrometer of any of the embodiments 1-12, further comprising a sample holder 1100 for holding the sample, wherein the sample holder comprises:
a vertical launch connector 1102 for physically connecting to a microstrip on the sample;
a metal plate 1104 comprising at least one opening 1112 for insertion of the sample and coupling of the electromagnetic radiation into the sample; and
fasteners 1106 (e.g. pins) for fastening the sample between the vertical launch connector and the metal plate so that the input signal is transmitted from the vertical launch connector to the microstrip and a reflection of the input signal (comprising the output signal) is outputted from the microstrip to the vertical launch connector.

14. The spectrometer of embodiment 13, further comprising a directional coupler 1108 coupling the vertical launch connector to:
the source of the input signal via a first coaxial cable 1100; and
the detection system via a second coaxial cable 1112.

15. The spectrometer of any of the embodiments 1-14, further comprising a time resolved vector network analyzer comprising the source of the input signal comprising a signal generator and the detection system comprising an oscilloscope triggered by a photodiode detecting the electromagnetic radiation.

16. The spectrometer of any of the embodiments 1-15, wherein the detection system measures and/or detects, or is configured to measure and/or detect, the change without time-resolution on a time-scale of the application of the electromagnetic radiation, and the computer determines the conductivity using normalization to exclude contributions of steady state heating by the input signal and for the sample comprising a thin film.

17. The spectrometer of any of the embodiments 1-16, wherein the detection system comprises an IQ demodulator coupled to a photodetector detecting, or configured to detect, the electromagnetic radiation, so that an amplitude and phase of the output signal (current and voltage) can be measured/detected using the IQ demodulator and associated with time resolution to changes in the time-envelope of the electromagnetic radiation, where I stands for the in-phase component of the signal and Q stands for the quadrature phase component.

18. The spectrometer of any of the embodiments 1-17, wherein the detection system measures and/or detects, or is configured to measure and/or detect, the output signal to determine a change in a complex impedance of the sample and the computer determines, or is configured/programmed to detect the conductivity from the complex impedance.

19. The spectrometer of any of the embodiments 1-18, wherein the detection system comprises an impedance analyzer.

20. The spectrometer of any of the embodiments 1-19, further comprising a vector network analyzer 1110 comprising the source of the input signal and the detection system.

21 The spectrometer of any of the embodiments 1-20, further comprising at least one of the source of the electromagnetic radiation, the source of the input AC signal (e.g., signal generator), or the VNA comprising the control circuit 106, wherein the control circuit comprises a trigger output, a clock circuit, or a clock output, or synchronizing circuit outputting a signal used to synchronize the source of the electromagnetic radiation and the source of the input AC signal.

22. The spectrometer of any of the embodiments 1-21, wherein the control circuit comprises a synchronizing circuit and/or a frequency divider circuit dividing the repetition rate of the pulses of electromagnetic radiation to a lower frequency signal used to trigger or control the AC source to output the input AC signal and the detection system (e.g., oscilloscope) to measure the output signal.

23. The spectrometer of any of the embodiments 1-22, wherein the control circuit and/or the computer comprise an application specific integrated circuit (ASIC) or integrated circuit, or processor executing one or more programs stored on a memory.

24. The spectrometer of any of the embodiments 1-23, wherein the source of electromagnetic radiation comprises a laser or a lamp.

25. The spectrometer of any of the embodiments 1-24 wherein the detection system comprises an oscilloscope and/or a detector capable of detecting the output signal and/or a vector network analyzer.

26. The spectrometer of any of the embodiments 1-25, wherein the detection system 112 comprises or consists of an AC electric field amplitude detector/circuit 1906, a phase locked loop detector/demodulator/circuit 1902, or an IQ demodulation circuit 1904 and optionally also an impedance matching circuit 1900 for impedance matching the detector to the sample. These components can be selected or configured to detect homodyne, heterodyne, amplitude modulated (AM), or frequency (FM) signals. The detector can further comprise a coaxial cable input 1908 or microstrip or transmission line for receiving the AC signal from the sample.

27. The spectrometer of any of the embodiments 1-25, wherein the detection system is a detector comprising at least one of an amplitude detecting circuit/circuitry 1906, a phase locked loop circuit/circuitry 1902, a impedance matching circuit/circuitry 1900, and/or an IQ demodulation circuit/circuitry 1904. In various embodiments, these circuits can optionally be selected or configured to detect (e.g., the output signal comprising) homodyne, heterodyne, amplitude modulated (AM), or frequency (FM) signals. The detector can optionally further comprise a coaxial cable input 1900 or microstrip or transmission line for receiving the AC signal from the sample.

28 The spectrometer of embodiment 26 or 27, comprising a VNA, oscilloscope, or lock-in amplifier in an impedance analyzer comprising the detector or at least one of the amplitude detector, IQ modulator, or PLL (phase locked loop).

29. The spectrometer of embodiments 27 or 28 further comprising a photodetector (e.g., photodiode) detecting the electromagnetic radiation, so that an amplitude and phase of the output signal (current and voltage) can be measured using the detector and associated with time resolution to changes in the time-envelope of the electromagnetic radiation,

30. A method of measuring conductivity (as illustrated in FIG. 16), comprising:
irradiating 1600 a region of a sample with electromagnetic radiation comprising one or more first frequencies;
applying 1602 an input signal to the region, the input signal comprising an alternating (AC) electric field comprising one or more second frequencies, so that the electromagnetic radiation and the input signal are applied synchronously;
measuring 1604 and/or detecting an output signal comprising a modulation of the AC electric field in response to:
the one or more second frequencies tuned to drive hopping of ions between sites in the sample, and
the one or more first frequencies tuned to drive excitations in the region that interact with the ions; and
determining (e.g., calculating) 1606, from the output signal, a conductivity of the sample as a function of the first frequencies and the second frequencies.

31. The method or spectrometer of any of the embodiments 1-29, wherein the sample comprises any material system (biological or non biological) conducting ions.

32. In one embodiment, including any of the embodiments 1-30, the method comprises laser-driven ultrafast impedance method that can directly measure bulk ion conduction on the picosecond timescale in terms of the sub-components of the ion hopping Hamiltonian. The technique takes advantage of advances in communications-based signal generators and oscilloscopes AC impedance measurements into the 100 GHz plus range. These frequencies compare to picosecond ion hopping in the site-to-site regime, although lower frequencies can of course be used to measure other hopping regimes such as at grain boundaries. Using these electronics, the time-resolved change in the impedance is then measured as a function of a femtosecond pulsed driving laser that is swept from the UV to THz. Within this frequency range lays the energy-gaps for the sub-components of the overall ion-hopping Hamiltonian. For example, UV light can photoexcite charge transfer transitions to modulate electrostatic blocking of ion channels or to create non-equilibrium carrier distributions to modulate screening effects. Near infrared to THz light can be used to resonantly excite optical phonon or rocking and paddlewheel modes. Acoustic phonon modes can be selected by anharmonic or Raman interactions or just incoherently heated as a reference channel. Comparing the amplitude of these perturbations maps out the relative role of each sub-component to the bulk ion hopping while comparing the time decays provides insight into correlation and memory effects.

33. Also described and tested is a version of the instrument which still maps the ion hopping Hamiltonian but at the sacrifice of time resolution. The second version realistically does not even need an ultrafast laser and therefore could be accessible to battery characterization laboratories as a form of action spectroscopy. The technique would then be suitable for rapid comparisons of material modifications like doping or grain size for a given material.

34. The spectrometer of any of the embodiments 1-33, wherein the computer 114 comprises one or more processors; one or more memories; and an application/program stored in the one or more memories, wherein the application executed by the one or more processors determines the impedance and/or conductivity.

35. The spectrometer of any of the embodiments 1-34, wherein the control circuit comprises one or more processors; one or more memories; and an application/program stored in the one or more memories, wherein the application executed by the one or more processors performs the synchronization or outputs signals used for synchronization.

In these examples (e.g., embodiments 1-35), the term “spectrometer” can be replaced with device, system, or apparatus.

30. A system 100, comprising:
a source 102 of electromagnetic radiation 102a comprising one or more first frequencies;
a source 104 of an input signal 104a comprising an alternating (AC) electric field comprising one or more second frequencies;
a synchronizing circuit, or means for synchronizing 106, 1700 operably connected to the sources 102, 104 for synchronizing application of the electromagnetic radiation and the AC electric field applied to a sample, so that an output signal comprising a modulation of the AC electric field is outputted from the sample in response to:
the one or more second frequencies tuned to drive hopping of ions between ion sites in the sample, and
the one or more first frequencies tuned to drive excitations in the sample that interact with the ions;
a detector or detector means, or means for detecting 112 operably connected to the sample holder for the sample, or positioned for, measuring and/or detecting a change in the output signal (e.g, an AC signal, e.g., comprising an electric field or voltage signal) in response to the electromagnetic radiation; and
a computer or computing unit or computer unit 114, 1700 operably connected to the detection system for determining at least one of a conductivity or impedance of the sample from the output signal and as a function of the first frequencies and the second frequencies.

31. The system of embodiment 30, wherein the means for synchronizing and means for detecting includes the devices described herein and equivalents thereof.

32. The system of embodiment 30 or 31 further comprising any of the embodiments 1-29.

33. The system, spectrometer, or method of any of the embodiments 1-32 wherein the detector or detection system 1914 comprises an input 1918 for receiving a trigger or synchronizing signal, or is connected to at least one of the synchronizing circuit/control circuit 106, 1912 or photodetector of the electromagnetic radiation that outputs the trigger or synchronizing signal.

34. The system or spectrometer of any of the embodiments 1-33, wherein:
the connection 124 between the control circuit or synchronizing circuit and the sources is wired (e.g., comprise a cable, coax, or transmission line for transmitting electrical signals) or wireless,
the connection 120 between the detector and the sample is wired (e.g., comprise a cable, coax, or transmission line for transmitting electrical signals) or wireless,
the connection 122 between the detector 1102, 1914 and the computer 114, 1700 is wired (e.g., comprise a cable, coax, or transmission line for transmitting electrical signals) or wireless.

35. The system or spectrometer of any of the embodiments 1-34, wherein the output signal and input signal comprise an AC electric field or voltage whose amplitude and/or phase can be measured by the detector 1914.

### Hardware Environment

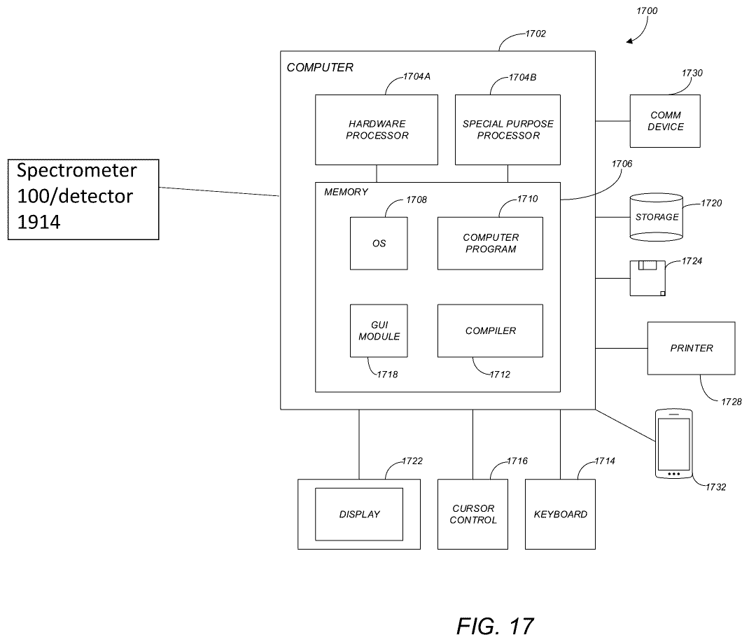

FIG. 17 is an exemplary hardware and software environment 1700 (referred to as a computer-implemented system and/or computer-implemented method) used to implement one or more embodiments of the invention, and which can be used as the control circuit or 106 or computer 114 in one or more embodiments. The hardware and software environment includes a computer 1702 and may include peripherals. Computer 1702 may be a user/client computer, server computer, or may be a database computer. The computer 1702 comprises a hardware processor 1704A and/or a special purpose hardware processor 1704B (hereinafter alternatively collectively referred to as processor 1704) and a memory 1706, such as random access memory (RAM). The computer 1702 may be coupled to, and/or integrated with, other devices, including input/output (I/O) devices such as a keyboard 1714, a cursor control device 1716 (e.g., a mouse, a pointing device, pen and tablet, touch screen, multi-touch device, etc.) and a printer 1728. In yet another embodiment, the computer 1702 may comprise a multi-touch device, mobile phone, or other internet enabled device executing on various platforms and operating systems.

In one embodiment, the computer 1702 operates by the hardware processor 1704A performing instructions defined by the computer program 1710 (e.g., conductivity calculating, control, or Hamiltonian calculating application) under control of an operating system 1708. The computer program 1710 and/or the operating system 1708 may be stored in the memory 1706 and may interface with the user and/or other devices to accept input and commands and, based on such input and commands and the instructions defined by the computer program 1710 and operating system 1708, to provide output and results.

Output/results may be presented on the display 1722 or provided to another device for presentation or further processing or action. The image may be provided through a graphical user interface (GUI) module 1718. Although the GUI module 1718 is depicted as a separate module, the instructions performing the GUI functions can be resident or distributed in the operating system 1708, the computer program 1710, or implemented with special purpose memory and processors.

In one or more embodiments, the display 1722 is integrated with/into the computer 1702 and comprises a multi-touch device having a touch sensing surface (e.g., track pod or touch screen) with the ability to recognize the presence of two or more points of contact with the surface.

Some or all of the operations performed by the computer 1702 according to the computer program 1710 instructions may be implemented in a special purpose processor 1704B. In this embodiment, some or all of the computer program 1710 instructions may be implemented via firmware instructions stored in a read only memory (ROM), a programmable read only memory (PROM) or flash memory within the special purpose processor 1704B or in memory 1706. The special purpose processor 1704B may also be hardwired through circuit design to perform some or all of the operations to implement the present invention. Further, the special purpose processor 1704B may be a hybrid processor, which includes dedicated circuitry for performing a subset of functions, and other circuits for performing more general functions such as responding to computer program 1710 instructions. In one embodiment, the special purpose processor 1704B is an application specific integrated circuit (ASIC) or field programmable gate array (FPGA).

The computer 1702 may also implement a compiler 1712 that allows an application or computer program 1710 written in a programming language such as C, C++, Assembly, SQL, PYTHON, PROLOG, MATLAB, RUBY, RAILS, HASKELL, or other language to be translated into processor 1704 readable code. Alternatively, the compiler 1712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1710 accesses and manipulates data accepted from I/O devices and stored in the memory 1706 of the computer 1702 using the relationships and logic that were generated using the compiler 1712.

The computer 1702 also optionally comprises an external communication device such as a modem, satellite link, Ethernet card, or other device for accepting input from, and providing output to, other computers 1702.

In one embodiment, instructions implementing the operating system 1708, the computer program 1710, and the compiler 1712 are tangibly embodied in a non-transitory computer-readable medium, e.g., data storage device 1720, which could include one or more fixed or removable data storage devices, such as a zip drive, floppy disc drive 1724, hard drive, CD-ROM drive, tape drive, etc. Further, the operating system 1708 and the computer program 1710 are comprised of computer program 1710 instructions which, when accessed, read and executed by the computer 1702, cause the computer 1702 to perform the steps necessary to implement and/or use the present invention or to load the program of instructions into a memory 1706, thus creating a special purpose data structure causing the computer 1702 to operate as a specially programmed computer executing the method steps described herein. Computer program 1710 and/or operating instructions may also be tangibly embodied in memory 1706 and/or data communications devices 1730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1702.

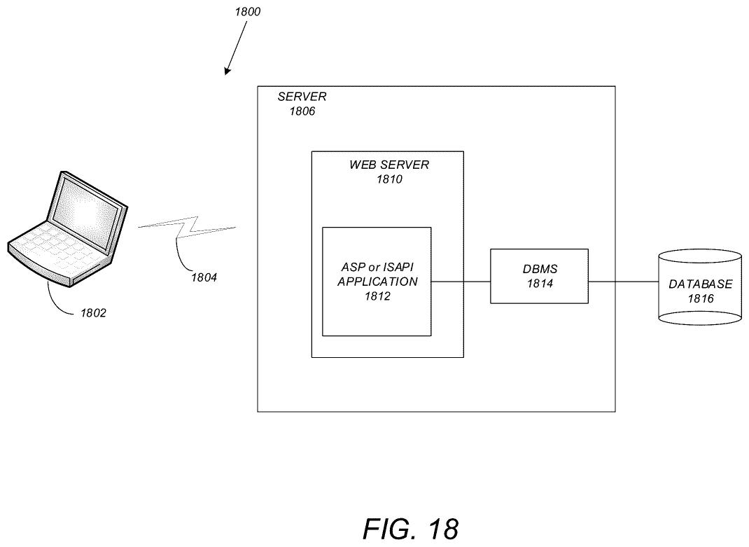

FIG. 18 schematically illustrates a typical distributed/cloud-based computer system 1800 using a network 1804 to connect client computers 1802 to server computers 1806. A typical combination of resources may include a network 1804 comprising the Internet, LANs (local area networks), WANs (wide area networks), SNA (systems network architecture) networks, or the like, clients 1802 that are personal computers or workstations (as set forth in FIG. 17), and servers 1806 that are personal computers, workstations, minicomputers, or mainframes (as set forth in FIG. 17). However, it may be noted that different networks such as a cellular network (e.g., GSM [global system for mobile communications] or otherwise), a satellite based network, or any other type of network may be used to connect clients 1802 and servers 1806 in accordance with embodiments of the invention.

A network 1804 such as the Internet connects clients 1802 to server computers 1806. Network 1804 may utilize ethernet, coaxial cable, wireless communications, radio frequency (RF), etc. to connect and provide the communication between clients 1802 and servers 1806. Further, in a cloud-based computing system, resources (e.g., storage, processors, applications, memory, infrastructure, etc.) in clients 1802 and server computers 1806 may be shared by clients 1802, server computers 1806, and users across one or more networks. Resources may be shared by multiple users and can be dynamically reallocated per demand. In this regard, cloud computing may be referred to as a model for enabling access to a shared pool of configurable computing resources.

Clients 1802 may execute a client application or web browser and communicate with server computers 1806 executing web servers 1810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1802 may be downloaded from server computer 1806 to client computers 1802 and installed as a plug-in or ACTIVEX control of a web browser. Accordingly, clients 1802 may utilize ACTIVEX components/component object model (COM) or distributed COM (DCOM) components to provide a user interface on a display of client 1802. The web server 1810 is typically a program such as MICROSOFT'S INTERNET INFORMATION SERVER.

Web server 1810 may host an Active Server Page (ASP) or Internet Server Application Programming Interface (ISAPI) application 1812, which may be executing scripts. The scripts invoke objects that execute business logic (referred to as business objects). The business objects then manipulate data in database 1816 through a database management system (DBMS) 1814. Alternatively, database 1816 may be part of, or connected directly to, client 1802 instead of communicating/obtaining the information from database 1816 across network 1804. When a developer encapsulates the business functionality into objects, the system may be referred to as a component object model (COM) system. Accordingly, the scripts executing on web server 1810 (and/or application 1812) invoke COM objects that implement the business logic. Further, server 1806 may utilize MICROSOFT'S TRANSACTION SERVER (MTS) to access required data stored in database 1816 via an interface such as ADO (Active Data Objects), OLE DB (Object Linking and Embedding DataBase), or ODBC (Open DataBase Connectivity).

Generally, these components 1800-1816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1802 and 1806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1802 and 1806. Embodiments of the invention are implemented as a software/CAD application on a client 1802 or server computer 1806. Further, as described above, the client 1802 or server computer 1806 may comprise a thin client device or a portable device that has a multi-touch-based display.

### Advantages and Improvements

In pump-probe spectroscopy, an ultrafast laser pulse impulsively initiates what would otherwise be a rare event near equilibrium, which fits the description of a thermally activated ion hop. However, an important distinction needs to be made for the technique presented here versus standard pump probe spectroscopy. Illustrative embodiments of our technique, unlike previous pump-probe iterations, do not attempt to directly trigger or induce ion conduction using the ultrafast laser pulse and then measure a change in a DC current, voltage, or some other metric like diffraction. Rather, a high frequency AC electric field is being used to constantly and cyclically drive ion hopping within the sample (e.g., solid state electrolyte). The ultrafast laser is then used to perturb different sub-systems (electrons, vibrational modes, displacement fields) that modulate the ion hopping process. The change in the amplitude and phase of the AC electric field then represents the change in the bulk impedance or conductivity from such a perturbation. In our testing, measuring the perturbation to an AC field proved critical for success because it overcomes the problems of trying to create an ultrafast DC field that creates ion motion across a device without having to worry about battery charge and discharge cycles. It also avoids the issue of trying to measure ion hopping simply by measuring the lifetime of a photoexcited perturbation and assuming its dynamics match bulk ion hopping dynamics.

The data presented herein shows that the laser-driven impedance method can measure the relative role of different components in the many-body, ion-hopping Hamiltonian through frequency-selective perturbation. For example, by directly driving highly contributing phonon modes, a 10× enhancement in ion migration is measured relative to incoherent heating. The results agree with the ab initio calculations, validating its use in exploring phonon mediated hopping. The methodology proven herein will aid in the design of future solid-state electrolytes and other ion hopping materials driven by vibrational modes. The results also hint at the potential for meta-stable light-induced states for ionic transport that could lead to new applications and sciences.

Moreover, the laser-driven ultrafast impedance technique presented here can directly measure ion hopping on picosecond and longer timescales while comparing the absolute and relative role of ion couplings to phonons, electrons, and other ions. Because the technique overcomes the challenges of other ultrafast time resolved approaches by utilizing the laser as a probe in an AC measurement, rather than using the laser to initiate ion conduction as a pump source, the described method ensures that the resulting transient or signal directly probes ion conduction. Although this study focuses on one type of Li⁺ conductor with low contributions to electronic conductivity, extensions to mixed ion-electron conducting systems or any solid or polymer ion conductor is certainly possible. Additionally, the costeffective, photo-modulated or action spectrum-like method provides a more lab-accessible route to probe complex ion-couplings, which can leverage the use of cost-effective light sources like a high-power, broad-spectrum lamps with a monochromator. Even though time-domain information about couplings and correlations are lost, the relative impact of different electronic and vibrational interactions can still be compared.

### REFERENCES

The following references are incorporated by reference herein.

### References for Section 2 and 4 (Second Example)

(1) Bubulinca, C.; Kazantseva, N. E.; Pechancova, V.; Joseph, N.; Fei, H.; Venher, M.; Ivanichenko, A.; Saha, P. Development of All-Solid-State Li-Ion Batteries: From Key Technical Areas to Commercial Use. Batteries 2023, 9 (3), 157. https://doi.org/10.3390/batteries9030157.
(2) Li, M.; Cao, Y.; Xiong, Y.; Qing, G. Hierarchically Engineered Nanochannel Systems with Pore-in/on-Pore Structures. NPG Asia Mater 2023, 15 (1), 1-17. https://doi.org/10.1038/s41427-022-00451-y.
(3) Zou, Z.; Li, Y.; Lu, Z.; Wang, D.; Cui, Y.; Guo, B.; Li, Y.; Liang, X.; Feng, J.; Li, H.; Nan, C.-W.; Armand, M.; Chen, L.; Xu, K.; Shi, S. Mobile Ions in Composite Solids. Chem. Rev. 2020, 120 (9), 4169-4221. https://doi.org/10.1021/acs.chemorev.960076.
(4) Li, X.; Benedek, N. A. Enhancement of Ionic Transport in Complex Oxides through Soft Lattice Modes and Epitaxial Strain. Chem. Mater. 2015, 27 (7), 2647-2652. https://doi.org/10.1021/acs.chemmater.5b00445.
(5) Bhandari, A.; Bhattacharya, J. Origin of Fast Ion Conduction in Li₁₀GeP₂S₁₂, a Superionic Conductor. J. Phys. Chem. C 2016, 120 (51), 29002-29010. https://doi.org/10.1021/acs.jpcc.6b10967.
(6) Choi, Y.-S.; Lee, J.-C. Electronic and Mechanistic Origins of the Superionic Conductivity of Sulfide-Based Solid Electrolytes. Journal of Power Sources 2019, 415, 189-196.
(7) Kraft, M. A.; Ohno, S.; Zinkevich, T.; Koerver, R.; Culver, S. P.; Fuchs, T.; Senyshyn, A.; Indris, S.; Morgan, B. J.; Zeier, W. G. Inducing High Ionic Conductivity in the Lithium Superionic Argyrodites Li₆₊ₓP₁₋ₓGeₓS₅I for All-Solid-State Batteries. J. Am. Chem. Soc. 2018, 140 (47), 16330-16339. https://doi.org/10.1021/jacs.8b10282.
(8) Kraft, M. A.; Culver, S. P.; Calderon, M.; Böcher, F.; Krauskopf, T.; Senyshyn, A.; Dietrich, C.; Zevalkink, A.; Janek, J.; Zeier, W. G. Influence of Lattice Polarizability on the Ionic Conductivity in the Lithium Superionic Argyrodites Li₆PS₅X (X=Cl, Br, I). J. Am. Chem. Soc. 2017, 139 (31), 10909-10918. https://doi.org/10.1021/jacs.7b06327.
(9) He, X.; Zhu, Y.; Mo, Y. Origin of Fast Ion Diffusion in Super-Ionic Conductors. Nat Commun 2017, 8 (1), 15893. https://doi.org/10.1038/ncomms15893.
(10) Muy, S.; Schlem, R.; Shao-Horn, Y.; Zeier, W. G. Phonon-Ion Interactions: Designing Ion Mobility Based on Lattice Dynamics. Advanced Energy Materials 2021, 11 (15), 2002787. https://doi.org/10.1002/aenm.202002787.
(11) Zhang, Z.; Li, H.; Kaup, K.; Zhou, L.; Roy, P.-N.; Nazar, L. F. Targeting Superionic Conductivity by Turning on Anion Rotation at Room Temperature in Fast Ion Conductors. Matter 2020, 2 (6), 1667-1684. https://doi.org/10.10166/j.matt.2020.04.027.
(12) Poletayev, A. D.; Hoffmann, M. C.; Dawson, J. A.; Teitelbaum, S. W.; Trigo, M.; Islam, M. S.; Lindenberg, A. M. The Persistence of Memory in Ionic Conduction Probed by Nonlinear Optics. arXiv May 30, 2022. https://doi.org/10.48550/arXiv 2110.06522.
(13) Xu, Z.; Chen, X.; Zhu, H.; Li, X. Anharmonic Cation-Anion Coupling Dynamics Assisted Lithium-Ion Diffusion in Sulfide Solid Electrolytes. Advanced Materials n/a (n/a), 2207411. https://doi.org/10.1002/adma.202207411.
(14) Krauskopf, T.; Muy, S.; Culver, S. P.; Ohno, S.; Delaire, O.; Shao-Horn, Y.; Zeier, W. G. Comparing the Descriptors for Investigating the Influence of Lattice Dynamics on Ionic Transport Using the Superionic Conductor Na₃PS₄₋ₓSeₓ. J. Am. Chem. Soc. 2018, 140 (43), 14464-14473. https://doi.org/10.1021/jacs.8609340.
(15) Muy, S.; Bachman, J. C.; Giordano, L.; Chang, H.-H.; Abernathy, D. L.; Bansal, D.; Delaire, O.; Hori, S.; Kanno, R.; Maglia, F.; Lupart, S.; Lamp, P.; Shao-Horn, Y. Tuning Mobility and Stability of Lithium Ion Conductors Based on Lattice Dynamics. Energy Environ. Sci. 2018, 11 (4), 850-859. https://doi.org/10.1039/C7EE03364H.
(16) Maiuri, M.; Garavelli, M.; Cerullo, G. Ultrafast Spectroscopy: State of the Art and Open Challenges. J. Am. Chem. Soc. 2020, 142 (1), 3-15. https://doi.org/10.1021/jacs.9b10533.
(17) Yang, T.-Y.; Gregori, G.; Pellet, N.; Grätzel, M.; Maier, J. The Significance of Ion Conduction in a Hybrid Organic-Inorganic Lead-Iodide-Based Perovskite Photosensitizer. Angewandte Chemie International Edition 2015, 54 (27), 7905-7910. https://doi.org/10.1002/anie.201500014.
(18) Kim, T.; Park, S.; Iyer, V.; Shaheen, B.; Choudhry, U.; Jiang, Q.; Eichman, G.; Gnabasik, R.; Kelley, K.; Lawrie, B.; Zhu, K.; Liao, B. Mapping the Pathways of Photo-Induced Ion Migration in OrganicInorganic Hybrid Halide Perovskites. Nat Commun 2023, 14 (1), 1846. https://doi.org/10.1038/s41467-02337486-w.
(19) Kim, G. Y.; Senocrate, A.; Yang, T.-Y.; Gregori, G.; Grätzel, M.; Maier, J. Large Tunable Photoeffect on Ion Conduction in Halide Perovskites and Implications for Photodecomposition. Nature Mater 2018, 17 (5), 445-449. https://doi.org/10.1038/s41863-018-0038-0.
(20) Goodenough, J. B. Review Lecture-Fast Ionic Conduction in Solid. Proceedings of the Royal Society of London. A. Mathematical and Physical Sciences 1997, 393 (1805), 215-234. bttps://doi.org/10.1098/rspa.1984.0055.
(21) Famprikis, T.; Canepa, P.; Dawson, J. A.; Islam, M. S.; Masquelier, C. Fundamentals of Inorganic Solid-State Electrolytes for Batteries. Nat. Mater. 2019, 18 (12), 1278-1291. https://doi.org/10.1038/s41563-019-0431-3.
(22) Zhang, Z.; Shao, Y.; Lotsch, B.; Hu, Y.-S.; Li, H.; Janek, J.; Nazar, L. F.; Nan, C.-W.; Maier, J.; Armand, M.; Chen, L. New Horizons for Inorganic Solid State Ion Conductors. Energy Environ. Sci. 2018, 11 (8), 1945-1976. https://doi.org/10.1039/CSEE010S3F.
(23) Janek, J.; Zeier, W. G. Challenges in Speeding up Solid-State Battery Development. Nat Energy 2023, 8 (3), 230-240. https://doi.org/10.1938/s41560-023-01208-9.
(24) Wang, S.; Zhang, J.; Gharbi, O.; Vivier, V.; Gao, M.; Orazem, M. E. Electrochemical Impedance Spectroscopy. Nat Rev Methods Primers 2021, 1 (1), 1-21. https://doi.org/10.1038/843586-021-00038-w.
(25) Irvine, J. T. S.; Sinclair, D. C.; West, A. R. Electroceramics: Characterization by Impedance Spectroscopy. Advanced Materials 1990, 2 (3), 132-138. https://doi.org/10.1002/adma.19900020304.
(26) Han, K. S.; Bazak, J. D.; Chen, Y.; Graham, T. R.; Washton, N. M.; Hu, J. Z.; Murugesan, V.; Mueller, K. T. Pulsed Field Gradient Nuclear Magnetic Resonance and Diffusion Analysis in Battery Research. Chem. Mater. 2021, 33 (22), 8562-8590. https://doi.org/10.1021/acs.chemmater.1c02891.
(27) Kuhn, A.; Kunze, M.; Sreeraj, P.; Wiemhöfer, H. D.; Thangadurai, V.; Wilkening, M.; Heitjans, P. NMR Relaxometry as a Versatile Tool to Study Li Ion Dynamics in Potential Battery Materials. Solid State Nucl Magn Reson 2012, 42, 2-8. https://doi.org/10.1016/j.ssnmr.2012.02.001.
(28) Fraenza, C. C.; Greenbaum, S. G. Broadband NMR Relaxometry as a Powerful Technique to Study Molecular Dynamics of Ionic Liquids. ChemPhysChem 2023, 24 (14), e202300268. https://doi.org/10.1002/cphc.202300268.
(29) Armstrong, J. Neutron Spectroscopy as a Method for Classical Force-Field Parameterization: Past Methods, Present Successes and Future Challenges. J. Phys. Commun. 2022, 6 (10), 102002. https://doi.org/10.1088/2399-6528/ac9728.
(30) Gardner, J. S.; Ehlers, G.; Faraone, A.; García Sakai, V. High-Resolution Neutron Spectroscopy Using Backscattering and Neutron Spin-Echo Spectrometers in Soft and Hard Condensed Matter. Nat Rev Phys 2020, 2 (2), 103-116. https://doi.org/10.1038/s42254-019-0128-1.
(31) Zhang, Z.; Nazar, L. F. Exploiting the Paddle-Wheel Mechanism for the Design of Fast Ion Conductors. Nat Rev Mater 2022, 7 (5), 389-405. https://doi.org/10.1038/s41578-021-00401-0.
(32) Krauskopf, T.; Culver, S. P.; Zeier, W. G. Bottleneck of Diffusion and Inductive Effects in Li₁₀Ge₁₋ₓSnₓP₂S₁₂. Chem. Mater. 2018, 30 (5), 1791-1798. https://dot org/10.1021/acs.chemmater.8b00266.
(33) Wilmer, D.; Feldmann, H.; Lechner, R. E.; Combet, J. Sodium Ion Conduction in Plastic Phases: Dynamic Coupling of Cations and Anions in the Picosecond Range. J. Mater. Res. 2005, 20 (8), 19731978. https://doi.org/10.1557/JMR.2005.0277.
(34) Defferriere, T.; Klotz, D.; Gonzalez-Rosillo, J. C.; Rupp, J. L. M.; Tuller, H. L. Photo-Enhanced Ionic Conductivity across Grain Boundaries in Polycrystalline Ceramics. Nat. Mater. 2022, 21 (4), 438-444. https://doi.org/10.1038/41563-021-01181-2.
(35) Lee, A.; Vörös, M.; Dose, W. M.; Niklas, J.; Poluektov, O.; Schaller, R. D.; Iddir, H.; Maroni, V. A.; Lee, E.; Ingram, B.; Curtiss, L. A.; Johnson, C. S. Photo-Accelerated Fast Charging of Lithium-Ion Batteries. Nat Commun 2019, 10 (1), 4946. https://doi.org/10.1038/s41467-019-12863-6.
(36) Först, M.; Mankowsky, R.; Cavalleri, A. Mode-Selective Control of the Crystal Lattice. Acc. Chem. Res. 2015, 48 (2), 380-387. https://doi.org/10.1021/ar500391x.
(37) Gordiz, K.; Muy, S.; Zeier, W. G.; Shao-Horn, Y.; Henry, A. Enhancement of Ion Diffusion by Targeted Phonon Excitation. CR-PHYS-SC 2021, 2 (5). https://doi.org/10.1016/j.xcrp.202.100431.
(38) Pham, K. H.; Gordiz, K.; Michelsen, J. M.; Liu, H.; Vivona, D.; Shao-Horn, Y.; Henry, A.; See, K. A.; Cushing, S. K. Many-Body Phonon-Ion Conduction in Solid Electrolyte Driven by THz Modes. arXiv May 2, 2023. https://doi.org/10.48580/arXiv.2305.01632.
(39) Först, M.; Manzoni, C.; Kaiser, S.; Tomioka, Y.; Tokura, Y.; Merlin, R.; Cavalleri, A. Nonlinear Phononics as an Ultrafast Route to Lattice Control. Nature Phys 2011, 7 (11), 854-856. https://doi.org/10.1038/nphys2055.
(40) Nova, T. F.; Cartella, A.; Cantaluppi, A.; Först, M.; Bossini, D.; Mikhaylovskiy, R. V.; Kimel, A. V.; Merlin, R.; Cavalleri, A. An Effective Magnetic Field from Optically Driven Phonons. Nature Phys 2017, 13 (2), 132-136. https://doi.org/10.1038/nphys3925.
(41) Morimoto, T.; Nagai, M.; Minowa, Y.; Ashida, M.; Yokotani, Y.; Okuyama, Y. Microscopic ion migration in solid electrolytes revealed by terahertz time-domain spectroscopy|Nature Communications. https://www.nature.com/articles/s41467-019-10501-9 (accessed 2020 Jun. 1).
(42) Tamimi, A.; Fayer, M. D. Ionic Liquid Dynamics Measured with 2D IR and IR Pump-Probe Experiments on a Linear Anion and the Influence of Potassium Cations. J. Phys. Chem. B 2016, 120 (26), 5842-5854. https://doi.org/10.1021/acs.jpcb.6b00409
(43) Michael Steer. Fundamentals of Microwave and RF Design, 3rd ed.
(44) Caspers, F. RF Engineering Basic Concepts: S-Parameters. arXiv Jan. 11, 2012. https://doi.org/10.48550/arXiv.1201.2346.
(45) Kubo, R. The Fluctuation-Dissipation Theorem. Rep. Prog. Phys. 1966, 29 (1), 255. https://doi.org/10.1088/0034-4885/29/1/306.
(46) Popkirov, G. S.; Schindler, R. N. A New Impedance Spectrometer for the Investigation of Electrochemical Systems. Review of Scientific Instruments 1992, 63 (11), 5366-5372. https://doi.org/10.1063/1.1143404.
(47) Creason, Sam. C.; Hayes, J. W.; Smith, D. E. Fourier Transform Faradaic Admittance Measurements III. Comparison of Measurement Efficiency for Various Test Signal Waveforms. Journal of Electroanalytical Chemistry and Interfacial Electrochemistry 1973, 47 (1), 9-46. https://doi.org/10.1016/800220728(73)80343-2.
(48) Valiūnienė, A.; Sabirovas, T.; Petronienė, J.; Ramanavičius, A. Towards the Application of Fast Fourier Transform-Scanning Electrochemical Impedance Microscopy (FFT-SEIM). Journal of Electroanalytical Chemistry 2020, 864, 114067. https://doi.org/10.1016/j.jelechem.2020.114067.
(49) Lyu, C.; Liu, H.; Luo, W.; Zhang, T.; Zhao, W. A Fast Time Domain Measuring Technique of Electrochemical Impedance Spectroscopy Based on FFT. In 2018 Prognostics and System Health Management Conference (PHM-Chongqing); 2018; pp 450-455. https://doi.org/10.1109/PHMChongqing.2018.00083.
(50) Xia, Z.; Abu Qahouq, J. A. High Frequency Online Battery Impedance Measurement Method Using Voltage and Current Ripples Generated by DC-DC Converter. In 2020 IEEE Applied Power Electronics Conference and Exposition (APEC); 2020; pp 1333-1338. https://doi.org/10.1109/APEC39645.2020.9124465.
(51) Xia, Z.; Qahouq, J. A. A. Method for Online Battery AC Impedance Spectrum Measurement Using DcDc Power Converter Duty-Cycle Control. In 2017 IEEE Applied Power Electronics Conference and Exposition (APEC); 2017; pp 1999-2003. https://doi.org/10.1109/APEC.2017.7930973.
(52) Popkirov, G. S. Fast Time-Resolved Electrochemical Impedance Spectroscopy for Investigations under Nonstationary Conditions. Electrochimica Acta 1996, 41 (7), 1023-1027. https://doi.org/10.1016/01346(95)00434-3.
(53) Kim, T.; Qiao, W.; Qu, L. Real-Time State of Charge and Electrical Impedance Estimation for LithiumIon Batteries Based on a Hybrid Battery Model. In 2013 Twenty-Eighth Annual IEEE Applied Power Electronics Conference and Exposition (APEC); 2013; pp 563-568. https://doi.org/10.1109/APEC.2013.652026
(54) Kežionis, A.; Kazakevičius, E.; Šalkus, T.; Orliukas, A. Broadband High Frequency Impedance Spectrometer with Working Temperatures up to 1200K. Solid State Ionics 2011, 188 (1), 110-113. https://doi.org/10.1016/j.ssi.2010.09.034.
(55) Kezionis, A.; Kazlauskas, S.; Petrulionis, D.; Orliukas, A. F. Broadband Method for the Determination of Small Sample's Electrical and Dielectric Properties at High Temperatures. IEEE TRANSACTIONS ON MICROWAVE THEORY AND TECHNIQUES 2014, 62 (10), 2456-2461.
(56) Peter C. L. Yip. High-Frequency Circuit Design and Measurements, 1st ed.; Chapman & Hall, 1990.
(57) Hager, N. E., III. Broadband Time-Domain-Reflectometry Dielectric Spectroscopy Using VariableTime-Scale Sampling. Review of Scientific Instruments 1994, 65, 887-891. https://doi.org/10.1063/1.1144917.
(58) Cole, R. H.; Berberian, J. G.; Mashimo, S.; Chryssikos, G.; Burns, A.; Tombari, E. Time Domain Reflection Methods for Dielectric Measurements to 10 GHz. Journal of Applied Physics 1989, 66 (2), 793802. https://doi.org/10.1063/1.343499
(59) Fourquet, J. L.; Duroy, H.; Crosnier-Lopez, M. P. Structural and Microstructural Studies of the Series La_{2/3-x}Li₃ₓ□_{1/3-2x}TiO₃. Journal of Solid State Chemistry 1996, 127 (2), 283-294. https://doi.org/jssc.1996.0385.
(60) Stramare, S.; Thangadurai, V.; Weppner, W. Lithium Lanthanum Titanates: A Review. Chem. Mater. 2003, 15 (21), 3974-3990. https://doi.org/10.1021/cm0300516.
(61) Zhang, L.; Zhang, X.; Tian, G.; Zhang, Q.; Knapp, M.; Ehrenberg, H.; Chen, G.; Shen, Z.; Yang, G.; Gu, L.; Du, F. Lithium Lanthanum Titanate Perovskite as an Anode for Lithium Ion Batteries. Nat Commun 2020, 11 (1), 3490. https://doi.org/10.1038/41467-020-17233-1.
(62) Guo, X.; Maram, P. S.; Navrotsky, A. A Correlation between Formation Enthalpy and Ionic Conductivity in Perovskite-Structured Li₃ₓLa_{0.67-x}TiO₃ Solid Lithium Ion Conductors. J. Mater. Chem. A 2017, 5 (25), 12951-12957. https://doi.org/10.1039/CTTA02434G.
(63) Šalkus, T.; Bohnke, O.; Macutkevic, J.; Orliukas, A. F.; Greičius, S.; Kezionis, A.; Krotkus, A.; Suzanovičienė, R.; Adomavičius, R. Peculiarities of Ionic Transport in LLTO Solid Electrolytes. physica status solidi c 2009, 6 (12), 2756-2758. https://doi.org/10.1002/pssc.200982527.
(64) Jonas, D. M. Two-Dimensional Femtosecond Spectroscopy. Annual Review of Physical Chemistry 2003, 54 (1), 425-463. https://doi.org/10.1146/annurev physchen.54.011002 103907.
(65) Cho, M. Coherent Two-Dimensional Optical Spectroscopy. Chem. Rev. 2008, 108 (4), 1331-1418. https://doi.org/10.1021/er078377b.
(66) V. E. Rogalin, I. A. Kaplunov, G. I. Kropotov. Optical Materials for the THz Range. Optics and Spectroscopy 2018, 125 (6), 851-863. https://doi.org/10.1134/80030400X18120172.

### References for Section 3 (First Example)

1. Bhandari, A. & Bhattacharya, J. Origin of Fast Ion Conduction in Li₁₀GeP₂S₁₂, a Superionic Conductor. J. Phys. Chem. C 120, 29002-29010 (2016).
2 Choi, Y.-S. & Lee, J.-C. Electronic and mechanistic origins of the superionic conductivity of sulfide-based solid electrolytes. Journal of Power Sources 415, 189-196 (2019).
3. Jun, K. et al. Lithium superionic conductors with corner-sharing frameworks. Nat. Mater. 21, 924-931 (2022).
4. Kamaya, N. et al. A lithium superionic conductor. Nature Mater 10, 682-686 (2011).
5. Kraft, M. A. et al. Inducing High Ionic Conductivity in the Lithium Superionic Argyrodites Li₆₊ₓP₁₋ₓGeₓS₅I for All-Solid-State Batteries. J. Am. Chem. Soc. 140, 16330-16339 (2018).
6. Manthiram, A., Yu, X. & Wang, S. Lithium battery chemistries enabled by solid-state electrolytes. Nat Rev Mater 2, 1-16 (2017).
7. Muy, S., Schlem, R., Shao-Horn, Y. & Zeier, W. G. Phonon-Ion Interactions: Designing Ion Mobility Based on Lattice Dynamics. Advanced Energy Materials 11, 2002787 (2021).
8. Weber, D. A. et al. Structural Insights and 3D Diffusion Pathways within the Lithium Superionic Conductor Li₁₀GeP₂S₁₂. Chem. Mater. 28, 5905-5915 (2016).
9. Krauskopf, T., Culver, S. P. & Zeier, W. G. Bottleneck of Diffusion and Inductive Effects in Li₁₀Ge₁₋ₓSnₓP₂S₁₂. Chem. Mater. 30, 17911798 (2018).
10. Kraft, M. A. et al. Influence of Lattice Polarizability on the Ionic Conductivity in the Lithium Superionic Argyrodites Li₆PS₅X (X=Cl, Br, I). J. Am. Chem. Soc. 139, 10909-10918 (2017).
11. Zhang, Z. et al. Targeting Superionic Conductivity by Turning on Anion Rotation at Room Temperature in Fast Ion Conductors. Matter 2, 1667-1684 (2020).
12. Smith, J. G. & Siegel, D. J. Low-temperature paddlewheel effect in glassy solid electrolytes. Nat Commun 11, 1483 (2020).
13. Zhang, Z. & Nazar, L. F. Exploiting the paddlewheel mechanism for the design of fast ion conductors. Nat Rev Mater 7, 389-405 (2022).
14. Li, X. & Benedek, N. A. Enhancement of Ionic Transport in Complex Oxides through Soft Lattice Modes and Epitaxial Strain. Chem. Mater. 27, 2647-2652 (2015).
15. Krauskopf, T. et al. Comparing the Descriptors for Investigating the Influence of Lattice Dynamics on Ionic Transport Using the Superionic Conductor Na₃PS₄₋ₓSeₓ. J. Am. Chem. Soc. 140, 14464-14473 (2018).
16. Först, M. et al. Nonlinear phononics as an ultrafast route to lattice control. Nature Phys 7, 854-856 (2011).
17. Vineyard, G. H. Frequency factors and isotope effects in solid state rate processes. Journal of Physics and Chemistry of Solids 3, 121-127 (1957).
18. Xu, Z., Chen, X., Zhu, H. & Li, X. Anharmonic Cation-Anion Coupling Dynamics Assisted Lithium-Ion Diffusion in Sulfide Solid Electrolytes. Advanced Materials n/a, 2207411.
19. Wilmer, D., Feldmann, H., Lechner, R. E. & Combet, J. Sodium Ion Conduction in Plastic Phases: Dynamic Coupling of Cations and Anions in the Picosecond Range. J. Mater. Res. 20, 1973-1978 (2005).
20. Brinek, M., Hiebl, C., Hogrefe, K., Hanghofer, I. & Wilkening, H. M. R. Structural Disorder in Li₆PS₅I Speeds ⁷Li Nuclear Spin Recovery and Slows Down ³¹P Relaxation-Implications for Translational and Rotational Jumps as Seen by Nuclear Magnetic Resonance. J. Phys. Chem. C 124, 22934-22940 (2020).
21. Wilkening, M. & Heitjans, P. From Micro to Macro: Access to Long-Range Li⁺ Diffusion Parameters in Solids via Microscopic ^{6,7}Li Spin-Alignment Echo NMR Spectroscopy. ChemPhysChem 13, 53-65 (2012).
22. Hanghofer, I., Gadermaier, B. & Wilkening, H. M. R. Fast Rotational Dynamics in ArgyroditeType Li₆PS₃X (X: Cl, Br, I) as Seen by ³¹P Nuclear Magnetic Relaxation-On CationAnion Coupled Transport in Thiophosphates. Chem. Mater. 31, 4591-4597 (2019).
23. Nova, T. F. et al. An effective magnetic field from optically driven phonons. Nature Phys 13, 132-136 (2017).
24. Hu, W. et al. Optically enhanced coherent transport in YBa₂Cu₃O_{6.5} by ultrafast redistribution of interlayer coupling. Nature Mater 13, 705-711 (2014).
25 Morimoto, T. et al. Microscopic ion migration in solid electrolytes revealed by terahertz timedomain spectroscopy. Nat Commun 10, 2662 (2019).
26. Poletayev, A. D. et al. The Persistence of Memory in Ionic Conduction Probed by Nonlinear Optics. Preprint at https://doi.org/10.48550/arXiv.2110.06522 (2022).
27 Gray, A. X. et al. Ultrafast terahertz field control of electronic and structural interactions in vanadium dioxide. Phys. Rev. B 98, 045104 (2018).
28. Gordiz, K., Muy, S., Zeier, W. G., Shao-Horn, Y. & Henry, A. Enhancement of ion diffusion by targeted phonon excitation. CR-PHYS-SC 2, (2021).
29 Muy, S. et al. Tuning mobility and stability of lithium ion conductors based on lattice dynamics. Energy Environ. Sci. 11, 850-859 (2018).
30. Zhang, B., Yang, L., Wang, L.-W. & Pan, F. Cooperative transport enabling fast Li-ion diffusion in Thio-LISICON Li₁₀SiP₂S₁₂ solid electrolyte. Nano Energy 62, 844-852 (2019).
31 Stramare, S., Thangadurai, V. & Weppner, W. Lithium Lanthanum Titanates: A Review. Chem. Mater. 15, 3974-3990 (2003).
32. Guo, X., Maram, P. S. & Navrotsky, A. A correlation between formation enthalpy and ionic conductivity in perovskite-structured Li₃ₓLa_{0.67-x}TiO₃ solid lithium ion conductors. J. Mater. Chem. A 5, 12951-12957 (2017).
33. Šalkus, T. et al. Peculiarities of ionic transport in LLTO solid electrolytes. physica status solidi c 6, 2756-2758 (2009).
34. Fourquet, J. L., Duroy, H. & Crosnier-Lopez, M. P. Structural and Microstructural Studies of the series LaLiTiO3, Journal of Solid State Chemistry 127, 283-294 (1996).
35. Greene, B. I., Saeta, P. N., Dykaar, D. R., Schmitt-Rink, S. & Chuang, S. L. Far-infrared light generation at semiconductor surfaces and its spectroscopic applications. IEEE Journal of Quantum Electronics 28, 2302-2312 (1992).
36. Zhang, L. et al. Lithium lanthanum titanate perovskite as an anode for lithium ion batteries. Nat Commun 11, 3490 (2020).
37 Liu, B. et al. Generation of narrowband, highintensity, carrier-envelope phase-stable pulses tunable between 4 and 18THz. Opt. Lett., OL 42, 129-131 (2017).
38. Laser-driven ultrafast impedance spectroscopy for measuring complex ion hopping processes, K. H. Pham, S. K. Cushing+ (2023), https://arxiv.org/abs/2310.09359
39. Many-body phonon-ion conduction in solid electrolyte driven by THz modes, K. H. Pham, K. Gordiz, J. M. Michelsen, H. Liu, D. Vivona, Y. Shao-Horn, A. Henry, K. A. See, S. K. Cushing (2023), https://arxiv.org/abs/2305.01632
40. Using Electron Energy-Loss Spectroscopy to Measure Nanoscale Electronic and Vibrational Dynamics in a TEM, Y.-J. Kim, L. D. Palmer, W. Lee, N. J. Heller, S. K. Cushing†, Journal of Chemical Physics (2023), doi: 10.1063/5.0147356

Further information on one or more embodiments of the present invention can be found in refs 38-39.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system, comprising:
a first source of electromagnetic radiation (EM) comprising one or more first frequencies;
a second source of an input signal comprising an alternating (AC) electric field comprising one or more second frequencies;
a control circuit connected to the first source and the second source for synchronizing application of the electromagnetic radiation and the AC electric field applied to a sample, so that an output signal comprising a modulation of the AC electric field is outputted from the sample in response to:
the one or more second frequencies tuned to drive hopping of ions between ion sites in the sample, and
the one or more first frequencies tuned to drive excitations in the sample that interact with the ions;
a detection system positioned for measuring and/or detecting a change in the output signal in response to the electromagnetic radiation; and
a computer connected to the detection system for determining at least one of a conductivity or impedance of the sample from the output signal and as a function of the first frequencies and the second frequencies.

2. The spectrometer of claim 1, wherein the control circuit controls or further comprising a control circuit for controlling:
a sweep of the first frequencies over a first range to drive the excitations of electrons, ions, and/or phonons in the sample comprising an electrolyte, and
a sweep of the second frequencies over a second range such that the input signal drives ion hopping in the electrolyte over a variety of ion migration time-scales.

3. The system of claim 2, wherein the computer determines, or is programmed to determine, a change in the conductivity at one or more of the second frequencies associated with the migration time-scales in different ion hopping regions in the electrolyte including at least one of a contact region, a grain boundary, or a bulk region.

4. The system of claim 3, wherein the electrolyte comprises a solid electrolyte for a battery.

5. The system of claim 4, wherein the sample comprises electrical contacts to the solid electrolyte comprising lithium ions for a lithium ion battery.

6. The system of claim 1, wherein computer determines or is programmed to determine, from the output signal, a Hamiltonian for the sample describing an interaction between the excitations excited by the electromagnetic radiation and the hopping driven by the input signal.

7. The system of claim 1, wherein the first source of electromagnetic radiation comprises a pulsed or continuous (CW) laser outputting the first frequencies in a range between an ultraviolet (UV) frequency and THz.

8. The system of claim 1, wherein the first source of electromagnetic radiation comprises a lamp outputting the electromagnetic radiation.

9. The system of claim 1, wherein the second source of the input signal comprises a signal generator outputting the second frequencies in a range from 1 Hz to 1THz.

10. The system of claim 1, wherein the detection system measures or comprises a circuit for measuring or detecting the output signal on a timescale of the excitations driven by the electromagnetic radiation.

11. The system of claim 1, wherein the first source of electromagnetic radiation comprises a pulsed laser for outputting pulses of the electromagnetic radiation having a full width at half maximum (FWHM) of 1 nanosecond or less and the detection system comprises a circuit for measuring the change with a time resolution of the envelope of the FWHM.

12. The system of claim 1, wherein the first frequencies comprise terahertz frequencies.

13. The system of claim 1, further comprising a sample holder for holding the sample, wherein the sample holder comprises:
a vertical launch connector for physically connecting to a microstrip on the sample;
a metal plate comprising at least one opening for insertion of the sample and coupling of the electromagnetic radiation into the sample; and
fasteners for fastening the sample between the vertical launch connector and the metal plate so that the input signal is transmitted from the vertical launch connector to the microstrip and a reflection of the input signal (comprising the output signal) is outputted from the microstrip to the vertical launch connector.

14. The system of claim 13, further comprising a directional coupler coupling the vertical launch connector to:
the second source of the input signal via a first coaxial cable; and
the detection system via a second coaxial cable.

15. The system of claim 1, further comprising a time resolved vector network analyzer comprising the second source of the input signal comprising a signal generator and the detection system comprising an oscilloscope triggered by a photodiode detecting the electromagnetic radiation.

16. The system of claim 1, wherein the detection system measures or comprises a circuit for measuring the change without time-resolution on a time-scale of the application of the electromagnetic radiation, and the computer is programmed for determining the conductivity using normalization to exclude contributions of steady state heating by the input signal and for the sample comprising a thin film.

17. The system of claim 1, wherein the detection system comprises an IQ demodulator coupled to a photodetector detecting the electromagnetic radiation, so that an amplitude and phase of the output signal (current and voltage) can be measured using the IQ demodulator and associated with time resolution to changes in the time-envelope of the electromagnetic radiation.

18. The system of claim 1, wherein the detection system comprises a circuit for measuring or detecting the output signal to determine a change in a complex impedance of the sample and the computer determines or is programmed for determining the conductivity from the complex impedance.

19. The system of claim 1, wherein the detection system comprises an impedance analyzer.

20. A method of measuring conductivity, comprising:
irradiating a region of a sample with electromagnetic radiation comprising one or more first frequencies;
applying an input signal to the region, the input signal comprising an alternating (AC) electric field comprising one or more second frequencies, so that the electromagnetic radiation and the input signal are applied synchronously;
measuring and/or determining an output signal comprising a modulation of the AC electric field in response to:
the one or more second frequencies tuned to drive hopping of ions between sites in the sample, and
the one or more first frequencies tuned to drive excitations in the region that interact with the ions; and
determining, from the output signal, a conductivity of the sample as a function of the first frequencies and the second frequencies.
